(19) United States
(12) Patent Application Publication
(10) Pub. No.: US 2025/0169495 A1
(43) Pub. Date: May 29, 2025

(54) COMPOSITIONS AND METHODS FOR CONTROLLING DROSOPHILA FLIES

(71) Applicants: Rutgers, The State University of New Jersey, New Brunswick, NJ (US); The United States of America, as represented by the Secretary of Agriculture, Washington, DC (US)

(72) Inventors: Cesar Rodriguez-Saona, New Brunswick, NJ (US); Amanda Quadrel, New Brunswick, NJ (US); Caitlin C. Rering, Gainesville, FL (US)

(73) Assignees: Rutgers, The State University of New Jersey, New Brunswick, NJ (US); The United States of America, as represented by the Secretary of Agriculture, Washington, DC (US)

(21) Appl. No.: 18/946,703

(22) Filed: Nov. 13, 2024

Related U.S. Application Data
(60) Provisional application No. 63/598,286, filed on Nov. 13, 2023.

(51) Int. Cl. A01N 37/02; A01N 25/02; A01N 37/06; A01P 7/04

(52) U.S. Cl. CPC A01N 37/02; A01N 25/02; A01N 37/06; A01P 7/04

(57) ABSTRACT

Provided herein are methods and compositions for controlling Drosophila flies on valuable agricultural crops.

### CROSS-REFERENCE TO RELATED APPLICATIONS

This application claims priority under 35 U.S.C. § 119 (e) to U.S. Provisional Patent Application No. 63/598,286, filed Nov. 13, 2023 which is incorporated herein by reference in its entirety.

### STATEMENT REGARDING FEDERALLY SPONSORED RESEARCH

This invention was made with government support under grant nos. FP00021261 and FP00017507 awarded by the United States Department of Agriculture. The government has certain rights in the invention.

### BACKGROUND

Spotted-wing drosophila (SWD), known as Drosophila suzukii, is a serious pest of thin-skinned fruits. SWD, unlike native species of Drosophila that reproduce in overripe or decomposing fruit, possess an ovipositor that allows for laying eggs in firm ripening fruit, resulting in damaged fruit that cannot be sold to consumers. Damage from SWD on fruit crops has been estimated to be in the hundreds of millions of US dollars. Due to its phenology, SWD is difficult to control with conventional pesticide sprays.

Consequently, there is an urgent and unmet need in developing control strategies for this damaging pest. The present disclosure provides a solution to this unmet need.

### BRIEF SUMMARY

In one aspect, the disclosure provides a composition consisting essentially of: about 1 to about 50% (v/v) of ethyl butanoate and (E)-ethyl but-2-enoate; and at least one suitable agriculturally-acceptable additive, wherein the ethyl butanoate and (E)-ethyl but-2-enoate are present in a ratio of about 1:1, 1:2, 1:3, 1:4, 1:5, 1:6, 1:7, 1:8, 1:9, 9:1, 8:1, 7:1, 6:1, 5:1, 4:1, 3:2, or 2:1 of ethyl butanoate: (E)-ethyl but-2-enoate.

In another aspect, the disclosure provides a method of repelling a Drosophila species fly from an agricultural crop, the method comprising: placing a repellent composition on or next to at least one plant in the agricultural crop, wherein the repellent composition consists essentially of at least one suitable agriculturally-acceptable additive and: about 1 to about 50% (v/v) of ethyl butanoate and optionally about 1 to about 50% (v/v) of (E)-ethyl but-2-enoate; or about 1 to about 50% (v/v) of (E)-ethyl but-2-enoate and optionally about 1 to about 50% (v/v) of ethyl butanoate.

In another aspect, the disclosure provides a method of suppressing or reducing oviposition of a Drosophila species fly on an agricultural crop, the method comprising: placing a repellent composition on or next to at least one plant in the agricultural crop, wherein the repellent composition consists essentially of at least one suitable agriculturally-acceptable additive and: about 1 to about 50% (v/v) of ethyl butanoate and optionally about 1 to about 50% (v/v) of (E)-ethyl but-2-enoate; or about 1 to about 50% (v/v) of (E)-ethyl but-2-enoate and optionally about 1 to about 50% (v/v) of ethyl butanoate.

In certain embodiments, the Drosophila species fly is Drosophila suzukii.

### BRIEF DESCRIPTION OF THE FIGURES

The drawings illustrate generally, by way of example, but not by way of limitation, various embodiments of the present application.

FIGS. 1A-1C illustrate non-limiting bioassay arenas used in this study. FIG. 1A: Multiple choice assays were conducted in arenas that consisted of a dome cage. Within the cage, gated traps containing blueberries and treatment were positioned in a circle at equal distance with each trap. A vial with moistened cotton in the center served as water source. FIG. 1B: Pairwise choice bioassays were conducted in arenas that consisted of clear plastic cups (946 mL). FIG. 1C shows a cartoon depiction of an experimental set up containing (1) mesh-covered opening for air circulation, (2) custom-made gated traps with blueberries and treatment inside, (3) Parafilm® with a hole in the center provided an entrance for the flies, (4) 1 mL polyethylene vial containing the volatile treatment (50 μL, neat) or control (no volatile) applied to a piece of cotton, and (5) vial with moisturized cotton that served as water source.

FIGS. 2A-2B illustrate volatile emission by fresh weight of Colletotrichum fioriniae-infected (orange circles) and uninfected (blue triangles) fruit in experimentally-infected fruit samples. FIG. 2A: A NMDS plot of volatile data with ellipses denoting 95% confidence limit. FIG. 2B: Total peak area over four days incubation. Means are points and error bars are standard error.

FIG. 3 illustrates Drosophila suzukii adults captured in a multiple-choice bioassay with blueberries. Bars represent mean % flies captured; error bars denote standard error. Different letters on bars indicate significant differences by Tukey tests at P≤0.05. Statistical tests were based on arcsine square-root transformed data. Means from untransformed data are shown. Compounds within the box captured significantly fewer flies than the control (black bar). The percent of responders and non-responders are presented in the circle at the top right of the figure. n=4.

FIG. 4 illustrates Drosophila suzukii adults captured in pairwise choice bioassays with blueberries. Bars represent mean % flies captured. An asterisk indicates significant differences between treatments at P≤0.05; n.s.=not significant (P>0.05). The percent of responders and non-responders are presented in the circle at the right of the figure. n=5.

FIG. 5 illustrates Drosophila suzukii adults captured in a multiple-choice bioassay with blueberries. Bars represent mean % flies captured; error bars denote standard error. Different letters on bars indicate significant differences by Tukey tests at P≤0.05. Statistical tests were based on arcsine square-root transformed data. Means from untransformed data are shown. The percent of responders and non-responders are presented in the circle at the top right of the figure. n=6.

FIGS. 6A-6D: Cage setups used in semi-field (picture, FIG. 6A; schematic representation, FIG. 6B) and field (picture, FIG. 6C; schematic representation, FIG. 6D) trials. In semi-field trials, each cage consisted of two potted blueberry bushes. In field trials, each cage contained five cultivated blueberry bushes. One of the bushes (focal bush) within the cage contained a polyethylene sachet with 2.5 mL of the repellent treatments: ethyl butanoate, ethyl (E)-but-2-enoate, or 2-pentylfuran. Control cages did not contain any repellent treatments.

FIGS. 7A-7C: Electroantennogram (EAG) response curves of male (solid lines) and female (dashed lines) Drosophila suzukii antennae to ethyl butanoate (FIG. 7A), ethyl (E)-but-2-enoate (FIG. 7B), and 2-pentylfuran (FIG. 7C). EAG amplitudes are presented as antennal depolarizations (mV±SE) normalized relative to the response to the hexane control. Different letters indicate significant differences among doses. N=10.

FIGS. 8A-8C: Effects of ethyl butanoate, ethyl (E)-but-2-enoate, and 2-pentyfuran on Drosophila suzukii oviposition (FIG. 8A), adult emergence (FIG. 8B), and survival from eggs to adults (FIG. 8C) in semi-field cage studies. An asterisk indicates significant differences between the control (white bars) and the treated (gray bars) berries within each cage. n.s.=no significant differences between the control and treatment. N=10.

FIG. 9: Effects of ethyl butanoate, ethyl (E)-but-2-enoate, and 2-pentyfuran on the deterrence index of Drosophila suzukii in semi-field cage studies. The deterrence index was calculated as (number of eggs per berry in the control-number of eggs per berry in the treatment)/total number of eggs per berry. Different letters indicate significant differences among treatments. N=10.

FIGS. 10A-10B: Effects of an untreated control, ethyl butanoate, ethyl (E)-but-2-enoate, and 2-pentyfuran on oviposition (A) and adult emergence (B) of Drosophila suzukii in field cages. Egg counts represent the mean number of eggs from a 10-berry subsample, while adult emergence refers to the average number of D. suzukii adults emerging from a 50-berry sample. N=4. For each data set (e.g., “Focal,” “Center,” and “End”), the bars from left to right are: control, 2-pentylfuran, ethyl butanoate, and ethyl (E)-but-2-enoate.

### DETAILED DESCRIPTION OF THE INVENTION

C. fioriniae infection changes the odor of blueberries by increasing emission of 14 volatiles. When analyzed individually, bioassays revealed D. suzukii adults are repelled by nine of these compounds, while two others were attractive, and three had neutral effects on their behavior. In particular, the esters ethyl butanoate and ethyl (E)-but-2-enoate were more or as repellent as the known D. suzukii repellents 1-octen-3-ol, geosmin, and 2-pentylfuran.

Most of the volatiles that explained the differences between infected vs. control fruit were present in both treatments, with four exceptions out of the 14 compounds identified, including 3-methyl-3-buten-1-ol and (E)-2-hexen-1-ol, which were never observed in control fruit, and 2-methylpropanal and ethyl 3-hydroxy-3-methylbutanoate, which were observed in only one replicate of field-collected control fruit and never in experimental control fruit. The similarity in volatiles emitted from infected vs. control berries suggests that D. suzukii aversion to infected berries is mediated by quantitative and not qualitative changes in volatile emission, i.e., specific ratios or amounts of volatiles emitted and not unique biomarkers of C. fioriniae infection.

Infection with C. fioriniae increased volatile emission of esters associated with ripe or overripe fruit, such as ethyl butanoate, ethyl propionate, and so forth. These compounds are frequently aroma components of various fruits including blueberry, guava, melon, banana, and apple. As such, they might be expected to act as attractants to the generalist D. suzukii. However, it was found that some were repellent. For example, ethyl butanoate (also called ethyl butyrate), a volatile with a fruity odor that elicits antennal response in D. suzukii, was identified here as a repellent when emitted at higher quantities in infected fruit. Other studies have also found this compound to elicit avoidance in D. suzukii. However, laboratory assays with ethyl butanoate found that the chemical was attractive when compared with a cotton-only control, although mixtures that excluded ethyl butanoate were more attractive than a mixture that included it. Similarly, a five-component volatile blend containing 3-methyl-1-butanol in ethanol was found to be as efficient at trapping D. suzukii as fermented juice. 3-methyl-1-butanol was identified as being repellent.

In the present study, bioassays always included uninfected ripe blueberries in both control and treatment samples, which may help explain differing results. Since both control and treatment samples in the present bioassays emitted a full blend of fruit-associated odors, differences in volatile emission between choices were quantitative, not qualitative. Drosophila suzukii flies are known to be very sensitive to fluctuations in fruit ripening odors. The present data further supports that D. suzukii adults can detect and respond accordingly to specific ratios and emission rates of compounds, which may signal underripe, ripe, or overripe, or infected/infested fruit.

In the present study, the identification of as many semiochemicals emitted from anthracnose-infected blueberries as possible was sought. Observed D. suzukii repellency was strong for many volatiles in our bioassays, indicating these compounds hold promise for use in the field.

Though the present study aimed to identify repellents for D. suzukii, two attractive volatiles were also identified. The first, 3-hydroxy-2-butanone (acetoin), is a ubiquitous fermentation volatile already known to attract D. suzukii adults. The second volatile, styrene, has previously been found attractive to other flies and has been detected at higher emission levels when blueberries are infected by phytopathogens, but until now D. suzukii response to this volatile was unknown.

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### Definitions

The term “about” as used herein can allow for a degree of variability in a value or range, for example, within 10%, within 5%, or within 1% of a stated value or of a stated limit of a range, and includes the exact stated value or range.

The term “agriculturally acceptable carrier” refers to a substance or composition that can be used to deliver an agriculturally beneficial agent to a plant (e.g., fruit plant), plant part (e.g., fruit), or plant growth medium (e.g., soil) without excessively and/or unacceptably adverse effects on plant growth, yield, or harmful effects to a consumer thereof.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less. The term “substantially free of” can mean having a trivial amount of, such that a composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “solvent” as used herein refers to a liquid that can dissolve a solid, liquid, or gas. Non-limiting examples of solvents are silicones, organic compounds, water, alcohols, ionic liquids, and supercritical fluids.

The term “independently selected from” as used herein refers to referenced groups being the same, different, or a mixture thereof, unless the context clearly indicates otherwise. Thus, under this definition, the phrase “X¹, X², and X³ are independently selected from noble gases” would include the scenario where, for example, X¹, X², and X³ are all the same, where X¹, X², and X³ are all different, where X¹ and X² are the same but X³ is different, and other analogous permutations.

The term “room temperature” as used herein refers to a temperature of about 15° C. to 28° C.

The term “standard temperature and pressure” as used herein refers to 20° C. and 101 kPa.

As used herein, the term “composition” or “pharmaceutical composition” refers to a mixture of at least one compound described herein with a pharmaceutically acceptable carrier. The pharmaceutical composition facilitates administration of the compound to a patient or subject. Multiple techniques of administering a compound exist in the art including, but not limited to, intravenous, oral, aerosol, parenteral, ophthalmic, pulmonary and topical administration.

As used herein, the term “effective amount,” refers to an amount of the disclosed repellent composition that is sufficient to provide the desired results, such as, for example, reducing the amount of Drosophila flies from laying eggs on a particular agricultural product (such as fruits and/or berries), or reducing the presence of Drosophila flies in the immediate vicinity of a particular agricultural product (such as fruits and/or berries). The term “immediate vicinity” refers to the distance at which a Drosophila fly could detect volatile organic compounds emitted by a ripening or ripened fruit or berry and cause the fly to change its behavior by, for example and without limitation, landing on the fruit. An effective amount can be administered in one or more administrations. For example, an effective amount of the composition may refer to an amount of the repellent composition that is sufficient to disrupt egg laying or feeding in Drosophila flies in a particular location.

### Drosophila-Repellent Compositions

In various embodiments, provided herein are repellent compositions that repel Drosophila sp. flies. In various embodiments, the Drosophila sp. fly is Drosophila suzukii.

In various embodiments, the repellent composition comprises ethyl butanoate and/or (E)-ethyl but-2-enoate. In various embodiments, the repellent composition consists essentially of ethyl butanoate, (E)-ethyl but-2-enoate, and a agriculturally acceptable carrier. In various embodiments, the repellent composition consists essentially of (E)-ethyl but-2-enoate and a agriculturally acceptable carrier. In various embodiments, the repellent composition consists essentially of ethyl butanoate and a agriculturally acceptable carrier. Ethyl butanoate and (E)-ethyl but-2-enoate can be prepared by synthetic methods known in the art. In various embodiments, the compounds ethyl butanoate and/or (E)-ethyl but-2-enoate is/are the only components in the repellent composition that repel Drosophila suzukii, and any other substance that can repel or does repel Drosophila suzukii, as described herein, is excluded from the repellent composition. In various embodiments, the compound ethyl butanoate is the only component in the repellent composition that repels Drosophila suzukii, and any other substance that can repel or does repel Drosophila suzukii, as described herein, is excluded from the repellent composition. In various embodiments, the compound (E)-ethyl but-2-enoate is the only component in the repellent composition that repels Drosophila suzukii, and any other substance that can repel or does repel Drosophila suzukii, as described herein, is excluded from the repellent composition.

In various embodiments, substances that do not repel Drosophila suzukii but reduce, enhance, add to, or take away from the repellent ability of ethyl butanoate and/or (E)-ethyl but-2-enoate are also excluded from the composition. In various embodiments, substances that do not repel Drosophila suzukii but reduce, enhance, add to, or take away from the repellent ability of ethyl butanoate are also excluded from the composition. In various embodiments, substances that do not repel Drosophila suzukii but reduce, enhance, add to, or take away from the repellent ability of (E)-ethyl but-2-enoate are also excluded from the composition. In various embodiments, the repellent composition does not contain or is substantially free of a substance that can repel Drosophila that contains free hydroxyl groups (OH). In various embodiments, the repellent composition is free of (does not contain) any 1-octen-3-ol.

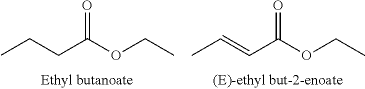

Whether a substance repels Drosophila suzukii can be determined by, for example, the experiments described herein.

The repellent composition, in various embodiments, contains about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99% (w/w) or (v/v) of ethyl butanoate. The repellent composition, in various embodiments, contains about 1 to about 99% (w/w) or (v/v) of ethyl butanoate.

The repellent composition, in various embodiments, contains about 1 to about 99% (w/w) or (v/v) of (E)-ethyl but-2-enoate. The repellent composition, in various embodiments, contains about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99% (w/w) or (v/v) of (E)-ethyl but-2-enoate.

In various embodiments, the repellent composition contains a mixture comprising about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99% (w/w) or (v/v) of ethyl butanoate and (E)-ethyl but-2-enoate.

When the repellent composition is a mixture of ethyl butanoate and (E)-ethyl but-2-enoate, each of ethyl butanoate and (E)-ethyl but-2-enoate can be present in a ratio of about 99:1 to about 1:99 of ethyl butanoate: (E)-ethyl but-2-enoate, or any ratio in between these values. In various embodiments, ethyl butanoate and (E)-ethyl but-2-enoate are present in a ratio of 1:1, 1:2, 1:3, 1:4, 1:5, 1:6, 1:7, 1:8, 1:9, 9:1, 8:1, 7:1, 6:1, 5:1, 4:1, 3:2, or 2:1 of ethyl butanoate: (E)-ethyl but-2-enoate.

The repellent compositions described herein can be used in an agricultural setting to prevent damage to crops such as fruit or berry crops. Examples of fruit that can be protected by the repellent composition include, without limitation, apples, oranges, peaches, grapes, pineapples, cherries, pears, guava, melon, banana, and the like. Examples of berries that can be protected by the repellent composition include, without limitation raspberries, blueberries, strawberries, blackberries, and the like.

The repellent compositions can include one or more suitable agriculturally-acceptable additives, for example, and without limitation antimicrobial agents, buffers, cleaning agents, compatibility agents, corrosion inhibitors, dispersing agents, drift reduction agents, dyes, emulsifiers, freezing point depressants, neutralizing agents, odorants, penetration aids, preservatives, sequestering agents, spreading agents, stabilizers, sticking/binding agents, surface-active agents (surfactants), thickening agents, and the like. The agriculturally-acceptable additives, in various embodiments, do not reduce, enhance, add to, or take away from the repellent ability of ethyl butanoate, (E)-ethyl but-2-enoate, or mixtures thereof.

The repellent compositions can also include one or more of a stabilizing agent, for example, and without limitation a filler such mineral clays (e.g., attapulgite), fatty acids and vegetable oils (e.g., olive oil, soybean oil, corn oil, safflower oil, and canola oil), a thickener, including, for example and without limitation, organic thickeners, methyl cellulose, and ethyl cellulose.

The repellent composition can also include one or more solid or liquid carriers. The solid or liquid carriers, in various embodiments, are inert (not chemically reactive and do not affect the behavior of fruit flies). Suitable inert solid carriers include, but are not limited to, magnesium oxide, silicates, synthetic silicas, calcium sulfate, dolomite, kaolin, attapulgites, loess, vegetable products (e.g., cereal meals, tree bark meal, wood meal, and nutshell meal), silica gels, calcium carbonate, talc, montmorillonites, China clay, limestone, powdered magnesia, cellulose powders, bentonite, dolomite, mineral earths such as silicas, gypsum, synthetic calcium silicates, rubber, mica, attaclay, chalk, Fuller's earth, wax, and fertilizers (e.g., ammonium sulfate, ammonium phosphate, ammonium nitrate, thiourea, and urea).

Suitable liquid carriers include, but are not limited to, water, alcohols (e.g., ethanol, methanol, butanol, glycol), aqueous solvent (e.g., mixtures of water and alcohols), ethers and esters (e.g., methylglycol acetate), ketones (e.g., acetone, cyclohexanone, methylethyl ketone, methylisobutylketone, and isophorone), aliphatic chlorinated hydrocarbons (e.g., trichloroethane and methylene chloride), aromatic hydrocarbons (e.g., xylenes and alkyl naphthalenes), petroleum solvents, turpentine, mineral oils, vegetable oils, aromatic chlorinated hydrocarbons (e.g., chlorobenzenes), water-soluble or strongly polar solvents (e.g., dimethylformamide, dimethyl sulfoxide, and N-methylpyrrolidone), waxes (e.g., beeswax, lanolin, shellac wax, carnauba wax, fruit wax, candelilla wax, microcrystalline wax, ozocerite, ceresin, and montan), and aqueous or water-soluble salts (e.g., monoethanolamine salt, sodium sulfate, potassium sulfate, sodium chloride, potassium chloride, sodium acetate, ammonium hydrogen sulfate, ammonium chloride, ammonium acetate, ammonium formate, ammonium oxalate, ammonium carbonate, ammonium hydrogen carbonate, ammonium thiosulfate, ammonium hydrogen diphosphate, ammonium dihydrogen monophosphate, ammonium sodium hydrogen phosphate, ammonium thiocyanate, ammonium sulfamate, and ammonium carbamate).

Suitable binders include, but are not limited to polyvinylpyrrolidone, polyvinyl alcohol, partially hydrolyzed polyvinyl acetate, carboxymethylcellulose, starch, vinylpyrrolidone/vinyl acetate copolymers and polyvinyl acetate, lubricants, magnesium stearate, sodium stearate, talc, and polyethylene glycol, antifoams, silicone emulsions, long-chain alcohols, phosphoric esters, acetylene diols, fatty acids, organofluorine compounds, and complexing agents (e.g., salts of ethylenediaminetetraacetic acid (EDTA), salts of trinitrilotriacetic acid, salts of polyphosphoric acids, shellac, acrylics, epoxies, alkyds, polyurethanes, linseed oil, and tung oil.

Suitable surfactants include, but are not limited to, surfactants usable for solubilization include nonionics (e.g., alky ethoxylates, linear aliphatic alcohol ethoxylates, and aliphatic amine ethoxylates), sorbitol esters (e.g., sorbitol oleate), sorbitan monooleates, sorbitan monooleate ethoxylates, methyl oleate esters, alkali metal, alkaline earth metal or ammonium salts of aromatic sulfonic acids, for example, ligno-, phenol-, naphthalene- and dibutylnaphthalenesulfonic acid, and of fatty acids of arylsulfonates, of alkyl ethers, of lauryl ethers, of fatty alcohol sulfates and of fatty alcohol glycol ether sulfates, condensates of sulfonated naphthalene and its derivatives with formaldehyde, condensates of naphthalene or of the naphthalenesulfonic acids with phenol and formaldehyde, condensates of phenol or phenolsulfonic acid with formaldehyde, condensates of phenol with formaldehyde and sodium sulfite, polyoxyethylene octylphenyl ether, ethoxylated isooctyl-, octyl- or nonylphenol, tributylphenyl polyglycol ether, alkylaryl polyether alcohols, isotridecyl alcohol, ethoxylated castor oil, ethoxylated triarylphenols, salts of phosphated triarylphenolethoxylates, lauryl alcohol polyglycol ether acetate, lignin-sulfite waste liquors, and methylcellulose.

Suitable thickeners include, but are not limited to, guar gum, locust bean gum, carrageenan, alginates, methyl cellulose, sodium carboxymethyl cellulose (SCMC), and hydroxyethyl cellulose (HEC).

In various embodiments, the repellent composition is formulated to be released into the atmosphere in a controlled manner, such as in a controlled release composition. Controlled release compositions include microencapsulated compositions, where the ethyl butanoate and/or (E)-ethyl but-2-enoate are present in a polymer-containing microsphere or microcapsule that allows for the slow diffusion of the ethyl butanoate and/or (E)-ethyl but-2-enoate into the atmosphere. Suitable polymers for such microspheres or microcapsules include, but are not limited to, celluloses (e.g., methylcellulose, ethyl cellulose, cellulose acetate, cellulose acetate-butyrate, cellulose acetate-propionate, and cellulose propionate), proteins (e.g., casein), fluorocarbon-based polymers, hydrogenated rosins, lignins, melamine, polyurethanes, vinyl polymers (e.g., polyvinyl acetate (PVAC)), polycarbonates, polyvinylidene dinitrile, polyamides, polyvinyl alcohol (PVA), polyamide-aldehyde, polyvinyl aldehyde, polyesters, polyvinyl chloride (PVC), polyethylenes, polystyrenes, polyvinylidene, and silicones. Other agents which can be used in slow-release or sustained-release formulations include fatty acid esters (e.g., a sebacate, laurate, palmitate, stearate, or arachidate ester), and fatty alcohols (e.g., undecanol, dodecanol, tridecanol, tridecenol, tetradecanol, tetradecenol, tetradecadienol, pentadecanol, pentadecenol, hexadecanol, hexadecenol, hexadecadienol, octadecenol and octadecadienol).

Each of the agriculturally-acceptable additives, liquid carriers, solid carriers, and polymers described herein, can be independently present in the repellent composition in amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, to about 99% (w/w) or (v/v) of the repellent composition.

In various embodiment, the repellent composition contains about 1 to about 50% (v/v) of a 1:1 mixture of ethyl butanoate and (E)-ethyl but-2-enoate in mineral oil. In various embodiment, the repellent composition contains about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, to about 50% (v/v) of a 1:1 mixture of ethyl butanoate and (E)-ethyl but-2-enoate in mineral oil. The percentage (v/v) of the ethyl butanoate and (E)-ethyl but-2-enoate refers to the combined amount of both the ethyl butanoate and (E)-ethyl but-2-enoate relative to the amount of mineral oil.

In various embodiment, the repellent composition contains about 1 to about 50% (v/v) of ethyl butanoate in mineral oil. In various embodiment, the repellent composition contains about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, to about 50% (v/v) of ethyl butanoate in mineral oil.

In various embodiment, the repellent composition contains about 1 to about 50% (v/v) of (E)-ethyl but-2-enoate in mineral oil. In various embodiment, the repellent composition contains about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, to about 50% (v/v) of (E)-ethyl but-2-enoate in mineral oil.

The repellent composition described herein can be used in combination with a chemical propagator. The chemical propagator can be any art recognized dispenser, such as an impregnated wicking material or other substrate, or incorporated in a dispenser. Controlled release over an extended period of time can be achieved by placement of the repellent composition in a vials, plastic sack, or other suitable container within a permeable septum, cap, or other opening; by encapsulation using conventional techniques, or by absorption into a porous substrate. Suitable chemical propagators include, but are not limited to, aerosol emitters, hand-applied dispensers, bubble caps comprising a reservoir with a permeable barrier through which the repellent composition is slowly released, pads, beads, tubes, rods, spirals or balls composed of rubber, plastic, leather, cotton, cotton wool, wood, polyvinyl chloride laminates, pellets, granules, and ropes or spirals from which the repellent composition evaporates. One of skill in the art will be able to select suitable carriers and/or dispensers for the desired mode of application, storage, transport, and/or handling conditions.

In various embodiment, a composition consisting essentially of about 1 to about 50% (v/v) of ethyl butanoate and (E)-ethyl but-2-enoate; and at least one suitable agriculturally-acceptable additive is provided. In various embodiments, the ethyl butanoate and (E)-ethyl but-2-enoate are present in a ratio of 1:1, 1:2, 1:3, 1:4, 1:5, 1:6, 1:7, 1:8, 1:9, 9:1, 8:1, 7:1, 6:1, 5:1, 4:1, 3:2, or 2:1 of ethyl butanoate: (E)-ethyl but-2-enoate.

In various embodiments, the at least one suitable agriculturally-acceptable additive comprises a liquid carrier.

In various embodiments, the liquid carrier is a petroleum solvent, mineral oil, vegetable oil, or a mixture thereof.

In various embodiments, the ethyl butanoate and (E)-ethyl but-2-enoate are present in a ratio of 1:1.

### Methods of Repelling Drosophila Flies

Provided herein are methods of repelling Drosophila from agricultural crops, such as fruits and/or berries. Also provided are methods of suppressing or reducing Drosophila suzukii oviposition on an agricultural crop. Examples of fruit that can be protected by the repellent composition include, without limitation, apples, oranges, peaches, grapes, pineapples, cherries, pears, guava, melon, banana, and the like. Examples of berries that can be protected by the repellent composition include, without limitation raspberries, blueberries, strawberries, blackberries, and the like. The method, in various embodiments, includes suppressing oviposition by preventing the flies from laying its eggs on growing fruit. The method includes releasing the repellent composition into the atmosphere/environment next to the agricultural crop and repelling at least 70, 80, 90, 95, 96, 97, 98, or 99% of Drosophila flies from eating, mating on, or laying eggs in the agricultural crop. In various embodiments, the method repels Drosophila suzukii. As used herein, the term “next to the agricultural crop” means placing the repellent composition or chemical propagator containing the repellent composition sufficiently close to the agricultural crop to effectively repel the Drosophila flies. In various embodiments, the repellent composition or chemical propagator containing the repellent composition is 0.1 to about 2 meters away from at least one plant in the agricultural crop. In various embodiments, each plant in the agricultural crop is not more than 2 meters away from the repellent composition or chemical propagator containing the repellent composition. In various embodiments, the chemical propagator is attached directly to at least one individual plant in the agricultural crop.

In various embodiments, the method of repelling Drosophila from agricultural crops includes a push-pull modality. The method includes releasing the repellent composition into the atmosphere/environment next to the agricultural crop and repelling at least 70, 80, 90, or 95% of Drosophila flies from eating, mating on, or laying eggs in the agricultural crop (the push) and providing an attractive substance for the flies to fly to (the pull). Suitable attractive substances include food odors and/or fermentation odors (from fermenting food products). In various embodiments, the attractive substance is placed in a container attached directly to an individual plant in the agricultural crop. In various embodiments, the attractive substance is placed in a trap that prevents the fruit fly from escaping once it enters the trap either through a physical barrier, killing of the fruit fly by a suitable insecticide in the trap, or a combination thereof.

In various embodiments, a method of repelling Drosophila suzukii from an agricultural crop is provided. In various embodiments, a method of suppressing or reducing Drosophila suzukii oviposition on an agricultural crop.

The methods include placing a repellent composition on or next to at least one plant in the agricultural crop. In various embodiments, the repellent composition consists essentially of: about 1 to about 50% (v/v) of ethyl butanoate and optionally about 1 to about 50% (v/v) of (E)-ethyl but-2-enoate; and at least one suitable agriculturally-acceptable additive. In various embodiments, the repellent composition consists essentially of: about 1 to about 50% (v/v) of (E)-ethyl but-2-enoate and optionally about 1 to about 50% (v/v) of ethyl butanoate; and at least one suitable agriculturally-acceptable additive.

In various embodiments, the repellent composition consists essentially of: about 1 to about 50% (v/v) of ethyl butanoate and (E)-ethyl but-2-enoate; and at least one suitable agriculturally-acceptable additive, wherein the ethyl butanoate and (E)-ethyl but-2-enoate are present in a ratio of 1:1, 1:2, 1:3, 1:4, 1:5, 1:6, 1:7, 1:8, 1:9, 9:1, 8:1, 7:1, 6:1, 5:1, 4:1, 3:2, or 2:1 of ethyl butanoate: (E)-ethyl but-2-enoate.

In various embodiments, the repellent composition is contained in a chemical propagator.

In various embodiments, the chemical propagator is attached directly to at least one individual plant in the agricultural crop.

In various embodiments, the agricultural crop is at least one of apples, oranges, peaches, grapes, pineapples, cherries, pears, guava, melon, banana, raspberries, blueberries, strawberries, or blackberries.

In various embodiments, the method further includes placing on or next to at least one plant in the agricultural crop an attractive substance that attracts Drosophila suzukii.

In various embodiments, the method repels or prevents at least 90% of Drosophila suzukii flies from eating, mating on, or laying eggs on the agricultural crop.

In various embodiments, the attractive substance is in a trap that prevents at least one Drosophila suzukii fly from escaping.

### EXAMPLES

Various embodiments of the present application can be better understood by reference to the following Examples which are offered by way of illustration. The scope of the present application is not limited to the Examples given herein.

### Materials and Methods

### 1. Fungal Isolates and Inoculant Preparation

Five C. fioriniae isolates were used in this experiment (Table 1). Strains were maintained on potato dextrose agar and incubated in the dark at 28° C. Inoculant solution was prepared by pouring sterile distilled water onto 7-day-old plates of C. fioriniae and gently scraped with an inoculation loop to liberate fungal spores from the agar. Spore suspension was then transferred from the plates and cell density determined by an automated cell counter (Bio-Rad TC20, Hercules, CA, USA). Final cell density in the inoculant solution was adjusted to 1×10⁷ cells/mL. Inoculant solutions were placed in small spray bottles for use in experiments.

TABLE 1
Colletotrichum fioriniae strains used in this
study and their GenBank accession numbers

GenBank accession number

| Strain | GAPDH | ITS | TUB2 |
|---|---|---|---|
| ACFK3 | MN689219 | MN684827 | MN689182 |
| ACFK12 | MN689227 | MN684835 | MN689190 |
| ACFK25 | MN689231 | MN684839 | MN689194 |
| ACFK145 | MN689233 | MN684841 | MN689196 |
| ACFK299 | MN689236 | MN684844 | MN689199 |

### 2. Sample Preparation

Two sample types were analyzed, “experimentally-infected” and “field-collected” fruit. For experimentally-infected samples, store bought organic blueberries were surface sterilized by submerging for 2 min each in first 10% bleach, then 70% ethanol, and finally sterile water. Berries were infected with the inoculant solution by liberally spraying fruit until run off. Control samples were sprayed with sterile water. Three replicates were prepared for each strain of experimentally-infected samples.

Field-collected fruit were harvested from a commercial highbush blueberry (Vaccinium corymbosum L.) farm in Hammonton, NJ. Fruit with visual signs of anthracnose infection (orange droplets seeping from berries) and control fruit with no signs of infection were shipped on ice in separate containers overnight to Gainesville, FL for volatile analysis. Three replicates were analyzed for field-collected fruit; however, one control replicate was lost (n=2 field-collected controls).

All berry samples (10-11 g, ca. 10 blueberries) were sealed in 4 oz (118 mL) Ball® glass jars with custom made PTFE lids, which were fitted with a gas chromatograph (GC) septum as described in Rering et al.³³ Samples were incubated at room temperature on the lab bench for one and four days for field-collected and experimentally-infected samples, respectively.

### 3. Volatile Analysis

Sample headspace was analyzed by gas chromatography mass spectrometry (GC-MS), following the methods previously described. Volatiles were collected from the experimentally-infected blueberries two and four days after inoculation. Field-collected samples were analyzed one day after receipt. Headspace was sampled by solid phase microextraction (SPME; Supelco, Bellefonte, PA, USA; 50/30 μm, 2 cm, divinylbenzene/carboxen/polydimethylsiloxane) fibers, which were inserted through the GC septum installed in the lid and allowed to collect volatiles for 15 min. Fibers were immediately injected in the GC inlet for 6 min at 230° C. to desorb volatiles which were separated by a DB-Wax column (60 m×320 μm×0.25 μm, J &W Scientific, Folsom, CA, USA). The MS was operated in positive scan mode with an electron ionization source. Technical replicates were also injected on a GC-MS outfitted with a non-polar DB-1 column (60 m×320 μm×0.25 μm) to assist in identification. After each sample was collected, the sample lid was removed in a biological safety cabinet for approx. 5 min to allow for gas exchange under sterile conditions.

Blueberry and fungal volatiles were identified by comparing sample and blank chromatograms. Compounds with similar abundance in both background (no fruit or C. fioriniae) and real samples were removed from the dataset. When compounds had elevated abundance in samples but were also present at lower levels in the background, sample peak areas were background subtracted.

Relative peak areas of a selected quantitative ion for each volatile were recorded using MassHunter Quantitative Analysis (Agilent Technologies, B.07.01, Palo Alto, CA, USA). Qualifier ions were monitored to confirm compound identity. Compound identities were tentatively assigned based on their match to the NIST library and retention indices (RIs) on polar and non-polar columns. Volatiles which were found to be emitted in higher amounts in anthracnose-infected fruits were confirmed by comparison to commercial standards. Identification results, quantitative and qualitative ions, and retention indices are described in Table 2.

### 4. Fly Rearing

The D. suzukii colony used for experiments was initiated in 2013 and maintained on a standard Drosophila artificial diet in a laboratory at Rutgers University (New Brunswick, NJ) at 22+2° C., 55+5% relative humidity (RH), and 16:8 (L:D) h. Wild flies were added every 2-3 years to the colony to help maintain genetic diversity. Male and female flies used in the experiments were 7-10 d old and thus were sexually mature. Flies were removed from the colony within 5 h from the start of the experiments.

### 5. Chemicals

For this study, 14 differentially emitted compounds were used from the anthracnose-infected blueberry fruit (Table 2). 3-Hydroxy-2-butanone (acetoin) (>96%, CAS No. 513-86-0), styrene (>98%, CAS No. 100-42-5), (E)-2-hexen-1-ol (96%, CAS No. 928-95-0), 2-methyl-1-butanol (>99%, CAS No. 137-32-6), ethyl propanoate (99%, CAS No. 105-37-3), 2-methyl-1-propanol (analytical standard, CAS No. 78-83-1), diethyl carbonate (>99%, CAS No. 105-58-8), 2-methylpropanal (>99%, CAS No. 78-84-2), 3-methyl-1-butanol (analytical standard, CAS No. 123-51-3), ethyl 2-methylpropanoate (99%, CAS No. 97-62-1), ethyl butanoate (99%, CAS No. 105-54-4), ethyl (E)-but-2-enoate (99%, CAS No. 623-70-1), and 3-methyl-3-buten-1-ol (97%, CAS No. 763-32-6) were purchased from Sigma-Aldrich (St. Louis, MO, USA). Ethyl 3-hydroxy-3-methylbutanoate (98%, CAS No. 18267-36-2) was purchased from AmBeed (Arlington Hts, IL, USA). Three known D. suzukii repellents were purchased from Sigma-Aldrich: 1-octen-3-ol (≥98%, CAS No. 3391-86-4), geosmin (≥97%, CAS No. 16423-19-1), and 2-pentylfuran (≥98%, CAS No. 3777-69-3).

TABLE 2
Volatiles detected in [symbol] floriniae-infected and control blueberries. Peak areas normalized by fresh weight are presented as mean ± SE. Peak areas were
measured by integrating the quantitative (quant.) ion and monitoring relative abundance of the qualitative (qual.) ion. Compounds in bold were significantly different between
experimentally-infected (exp. infected) and experimental control (exp. control) fruit. Italicized compounds were repellent Drosophila su [symbol] in bioassays

Retention Index

| | | | |
|---|---|---|---|
| Mean peak area (±SE) | Non- | Quant. | Qual. |

| Class | Chemical | Exp. infected | Exp. Control | Field infected | Field Control | Polar | polar | ion | ion |
|---|---|---|---|---|---|---|---|---|---|
| Aldehyde | 2-methylpropanol [symbol] | 34 (±14) [symbol] | 0 [symbol] | 4894 (±2200) | 17 (±17) | [symbol] 14 | NA | 72 | 41 |
| | acetaldehyde [symbol] | 4.39e4 (± [symbol] 7e3) | 2.24e4 (±6.2e3) | 2.75e5 (±1e5) | 5.01e3 (±3.5e3) | NA | NA | 44 | NA |
| Alcohol | 2-methyl-1-propanol [symbol] | 1.03e4 (±1.1e3) [symbol] | 2112 (±1145) [symbol] | 1.03e5 (2.6e4) | 4085 (±3576) | 1101 | 620 | 43 | 74 |
| | 2-methyl-1-but [symbol] nol [symbol] | 1842 (±337) [symbol] | 342 (±148) [symbol] | 8. [symbol] e4 (±1.4e4) | 464 (±242) | 1210 | 721 | 57 | 70 |
| | 3-methyl-1-but [symbol] nol [symbol] | 2186 ( [symbol] 20) [symbol] | 569 (±205) [symbol] | 3.74e4 (±1.2e4) | 259 (±37) | 1211 | 718 | 57 | 70 |
| | 3-methyl-3-buten-1-ol [symbol] | 90 (±13) [symbol] | 0 [symbol] | 915 (±310) | 0 | 1251 | 713 | 56 | 68 |
| | (E)-2-hexen-1-ol [symbol] | 28 (±11) [symbol] | 0 [symbol] | 32 (±17) | 0 | 1409 | 850 | 57 | 67 |
| | isopropyl alcohol | 611 ( [symbol] 90) | 908 ( [symbol] 4 [symbol] 08) | 0 | 146 (±146) | 929 | NA | 59 | NA |
| | Ethanol | 1.46e6 (±6.7e4) | 6.39e5 (±1.1e [symbol] ) | 1.27e6 (±3.7e [symbol] ) | 6.97e4 ( [symbol] e4) | 936 | NA | 45 | NA |
| | 1-propanol | 984 (±60) | 350 (±110) | 1.586 (±562) | 0 | 1039 | NA | 59 | 42 |
| | 1-methoxy-2-propanol | 155 (±30) | 446 (±53) | 85 (±28) | 542 (±118) | 1133 | ND | 45 | 58 |
| | 1-butenol | 84 (±16) | [symbol] 1 (±46) | 482 (±263) | 12 (±12) | 1149 | 649 | 56 | 41 |
| | 1-hexanol | 226 (± [symbol] 3) | 371 (±286) | 2190 (±92.3) | 0 | 1357 | 854 | 56 | 69 |
| | 3-hexen-1-ol | 52 (±15) | 31 (±31) | 369 (±92) | 0 | 1387 | 840 | 67 | 53 |
| Benzenoid | styrene [symbol] | 8.52e4 (±2.6e4) [symbol] | 7.01e3 (±3.0e3) [symbol] | 9.05e3 (±2.4e3) | 635 (±300) | 1254 | 874 | 104 | 78 |
| | Toulene | 0 | 0 | 2042 (±307) | 1534 (±232) | 1039 | 752 | 91 | 65 |
| | [symbol] - [symbol] ymene | 278 (±54) | 5969 (±5734) | 129 (±43) | 30 (±30) | 1268 | ND | 119 | 134 |
| | 4-ethe [symbol] yl-1,2-dimethylbenzene [symbol] | 34 (±15) | 19 (±19) | 0 | 0 | 1436 | ND | 132 | 117 |
| | 1-(4-methylphenyl)ethanol [symbol] | 176 (±32) | 319 (±112) | 87 (±87) | 475 (±32) | 1471 | ND | 121 | 93 |
| | ethyl benzoate | 2109 (±374) | 554 (±232) | 2243 (±1897) | 233 (±136) | 1667 | 1144 | 105 | 77 |
| | benzyl alcohol | 8 (±5) | 0 | 641 (±58) | 0 | 1876 | 1004 | 79 | 108 |
| | 2-phenylethanol | 7 (±7) | 0 | 2518 (±630) | 0 | 1912 | ND | 91 | 122 |
| Carboxylic acid | 2-methyl-propanoic acid | 0 | 0 | 1.08e4 ( [symbol] 9.4e3) | 0 | 1570 | ND | 43 | 73 |
| Ester | ethyl propanoate [symbol] | 2.17e4 (±3.3e3) [symbol] | 2802 (±1034) [symbol] | 1.2e4 (±3.4e3) | 95 (±9 [symbol] 5) | 956 | 694 | 57 | 102 |
| | ethyl 2-methylpropanoate [symbol] | 6591 (±7 [symbol] 82) [symbol] | 920 (±529) [symbol] | 2594 (±696) | 165 (±30) | 965 | 743 | 116 | 41 |
| | ethyl butanoate [symbol] | 8093 (±1045) [symbol] | 774 (±242) [symbol] | 1.04e4 (3 [symbol] 3) | 163 (±69) | 10 [symbol] 6 | 783 | 71 | 88 |
| | diethyl carbonate [symbol] | 4060 (±875) [symbol] | 175 (±13) [symbol] | 662 (±136) | 0 | 1106 | 761 | 91 | 63 |
| | ethyl (E)-but-2- [symbol] | 1.25e4 (±1.5e3) [symbol] | 1851 (±796) [symbol] | 4842 (±1851) | 0 | 1162 | 823 | 69 | 99 |
| | ethyl 3-hydroxy-3- | 138 (±34) [symbol] | 0 [symbol] | 3173 (±475) | 26 (±26) | 1413 | 932 | 59 | 43 |
| | methylbutanoate [symbol] | | | | | | | | |
| | methyl acetate | 3051 (±363) | 1605 (±715) | 8854 (±3353) | 118 (±118) | 827 | NA | 74 | 59 |
| | ethyl acetate | 1.12e5 (±1.6e4) | 2.94e4 (±1.4 [symbol] 4)) | 8.52e4 (±2.0 [symbol] 4) | 308 (±118) | 888 | 608 | 61 | 70 |
| | methyl 2-methylbutanoate | 417 (±25) | 316 (±125) | 4334 (±2932) | 9896 (±85 [symbol] 86) | 1011 | ND | 88 | 57 |
| | 2-methylpropyl [symbol] acetate | 461 (±56) | 140 (±70) | 5913 (±1662) | 0 | 1014 | 756 | 56 | 43 |
| | methyl 3-methylbutanoate | 1.13e4 (±1.4e3) | 8.96e3 (±4.9e3) | 3.18e4 (±1.8e4) | 1.63e5 (±1.5e5) | 1019 | 760 | 74 | 59 |
| | ethyl 2-methylbutanoate | 2.92e4 (±3.5e3) | 1.35e4 (±5e3) | 7.14e4 (±2.5e4) | 1.18e4 (±7.3e3) | 1052 | 837 | 57 | 102 |
| | ethyl 3-methylbutanoate | 4.34e5 (±3e4) | 2.73e5 (1e5) | 3.60e5 (±9.6e4) | 1.07e5 (±5.1e4) | 1068 | 839 | 88 | 57 |
| | 3-methylb [symbol] tyl acetate | 646 (±116) | 540 (±285) | 3.86e4 (±2.0e4) | 0 | 1122 | 861 | 43 | 70 |
| | ethyl 2-methyl [symbol] -2 [symbol] | 216 (±33) | 34 (±34) | 438 (±122) | 0 | 1161 | ND | 128 | 55 |
| | 2-methylpropyl 3-methylbutanoate | 126 (±38) | 147 (±147) | 1524 (±732) | 62 (±62) | 1190 | 992 | 85 | 57 |
| | 3-methylbutyl 3-methylbutanoate | 69 (±27) | 37 (±37) | 617 (±211) | 0 | 1295 | ND | 70 | 55 |
| | ethyl 2-hydroxypentanoate [symbol] | 198 (±38) | 74 (±74) | 91 (±44) | 49 (±49) | 1427 | 950 | 73 | 55 |
| | 2-nitroethyl propanoate [symbol] | 80 (±19) | 0 | 3668 (±637) | 0 | 1542 | ND | 45 | 57 |
| Ketone | 3-hydroxy-2-butanone (acet [symbol] n) [symbol] | 1.05e4 (±2.0e3) [symbol] | 983 (±388) [symbol] | 1.93e5 (±2.6e4) | 299 (±215) | 1285 | 681 | 45 | 88 |
| | Acetone | 1.49e4 (±1.2e3) | 1.63e4 (±7.4 [symbol] ) | 2052 (±798) | 130 (±7) | 816 | NA | 58 | |
| | 2-butanone | 142 (±21) | 27 (±19) | 638 (±57) | 88 (±60) | 903 | NA | 72 | 57 |
| | 3-ethyl-4-methylheptane-3-one [symbol] | 1 [symbol] 27 (±195) | 715 (±241) | 3044 (±600) | 310 (±110) | 978 | 674 | 57 | 86 |
| | 2-heptanone | 0 | 0 | 867 (±64) | 0 | 1180 | ND | 58 | 71 |
| | ethyl 3-methylbut-3 [symbol] | 1367 (±364) | 1373 (±1187) | 1.14e3 (±3.0e3) | 53 (±2 [symbol] 1) | 1225 | 904 | 83 | 128 |
| | 6-methyl-5-heptene-2-one | 0 | 0 | 1092 (±157) | 0 | 1337 | ND | 108 | 55 |
| Monote [symbol] pene | [symbol] -phellandrene | 177 (±32) | 823 (±534) | 0 | 27 (±27) | 1159 | ND | 93 | 105 |
| | [symbol] monene | 1250 (±346) | 3307 (±1870) | 173 (±54) | 115 (±23) | 1196 | 1020 | 68 | 93 |
| | [symbol] monene | 57 (±29) | 216 (±103) | 0 | 0 | 1202 | ND | 68 | 93 |
| | β- [symbol] cimene | 101 (±59) | 89 (±45) | 364 (±102) | 270 (±102) | 1249 | ND | 93 | 79 |
| | Terpinolene | 162 (±60) | 412 (±290) | 0 | 0 | 1281 | 1078 | 121 | 93 |
| | Linal [symbol] l | 95 (±25) | 331 (±114) | 185 (±42) | 0 | 1550 | 1084 | 93 | 71 |
| Monoterpenoid | Eucalyptol | 132 (±18) | 187 (±57) | 410 (±276) | 9 (±9) | 1209 | 1019 | 108 | 154 |
| | dihydroca [symbol] | 243 (±56) | 272 ( [symbol] 176) | 207 (±58) | 0 | 1210 | 981 | 82 | 96 |
| | anhydrolinal [symbol] l [symbol] xide | 433 (±124) | 628 (±522) | 170 (±85) | 0 | 1243 | 993 | 67 | 55 |
| Other | dimethyl sulfide [symbol] | 262 (±25) | 197 (±78) | 1403 (±417) | 1673 (±384) | NA | NA | 62 | 47 |
| | 2-metylfuran | 2028 (±236) | 638 (±271) | 7345 (±1916) | 1842 (±818) | 898 | 612 | 82 | 53 |
| | hexylhydro [symbol] peroxide [symbol] | [symbol] | 0 | 216 (±114) | 0 | 1317 | ND | 56 | 41 |
| S [symbol] pene | [symbol] -cary [symbol] | 153 (±9) | 137 (±35) | 0 | 0 | 1598 | 1412 | 91 | 133 |
| Unknown | unknown (79 (100), 93 (64), 94 | 152 (±32) | 235 (±136) | 18 (±18) | 0 | 1325 | 1058 | 79 | 93 |
| | (48), 137 (44), 91 (34), 152 | | | | | | | | |
| | (28), 43 (25), 77 (24), 95 (14), | | | | | | | | |
| | 92 (13)) | | | | | | | | |

^{a}Compound identity confirmed by standard injection.
^{b}Compound tentative identity confirmed by library match. Unmarked compound name indicates library and RI match. An unidentified compound is listed with 10 most abundant fragments (relative abundance). [symbol]
Indicates significant differences in abundance between exp. infected and exp. control fruit ( [symbol] = 0.01). ND indicates an RI value could not be calculated because the compound was not observed on this column, or that no suitable qual [symbol] ion was available [symbol] NA indicates an RI value could not be calculated because it fell outside of the range of alkanes used [symbol]
indicates data missing or illegible when filed

6. Multiple Choice Bioassays #1: Comparing D. suzukii Responses to Anthracnose-Induced Volatiles

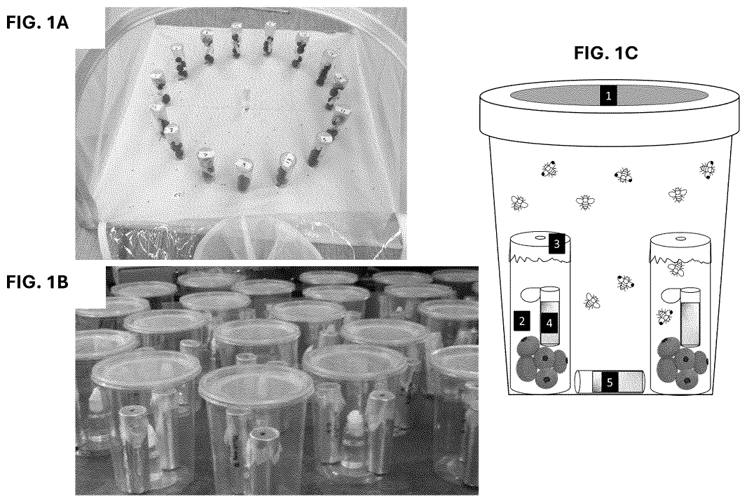

To screen for behavioral effects among volatiles that were significantly different between anthracnose-infected and control fruit on D. suzukii adults, a multiple choice bioassay was conducted as previously described. These bioassays were done in arenas that consisted of a dome cage (60 cm width×60 cm length x 60 cm height; BugDorm-2120 Insect tent; shop.bugdorm.com) (FIG. 1A). Within each arena, 15 gated traps were positioned randomly in a circle (40 cm diameter) at equal distance with each trap 8.4 cm apart along the circumference (FIG. 1A). Each gated trap consisted of 50 mL polystyrene tubes (Fisher Scientific, Nazareth, PA, USA) covered with aluminum foil and sealed with Parafilm®, with a 4 mm-diameter hole in the center of the Parafilm to provide an entrance to flies. All traps had equal quantities (ca. 5 g) of store-bought organic blueberry fruit (n=5); fruit were sterilized with bleach prior to the study (10% bleach for 2 min, rinsed three times in distilled water). One of the 15 traps served as a control (with blueberry fruit only) and the remaining 14 traps had one of the anthracnose volatile compounds added to the blueberry fruit. The 14 compounds tested were: 3-hydroxy-2-butanone, styrene, (E)-2-hexen-1-ol, ethyl 3-hydroxy-3-methylbutanoate, 2-methyl-1-butanol, ethyl propanoate, 2-methyl-1-propanol, diethyl carbonate, 2-methylpropanal, 3-methyl-1-butanol, ethyl 2-methylpropanoate, ethyl butanoate, ethyl (E)-but-2-enoate, and 3-methyl-3 buten-1-ol (see Results). Each volatile (50 μL, neat) was released from a 1 mL polyethylene vial (Globe Scientific Inc., Paramus, NJ, USA) with a piece of cotton placed inside each trap (control traps had vials with cotton but without the volatile). A vial with a cotton ball soaked with deionized water was placed in the middle of the arena to provide flies with water during the experiment. Roughly 300 D. suzukii adults (1:1 male: female ratio) were released inside each arena and the number and sex of flies inside treatment and control traps was recorded after 24 h. The experiment started at 1:00 p.m., was replicated 4 times, and was done in a laboratory under 22+2° C., 55+5% RH, 16:8 (L:D) h.

7. Pairwise Choice Bioassays: Evaluating D. suzukii Response to Putative Anthracnose-Emitted Repellents

To investigate the effects of individual repellent compounds from anthracnose-infected fruit (identified from Section 6) on D. suzukii adults, pairwise choice bioassays were performed. These bioassays consisted of arenas using clear plastic cups (946 mL, 114 mm diameter, 127 mm height; Paper Mart, CA, USA) (FIG. 1B). Flies were given a choice between blueberry fruit without a repellent (control) and blueberry fruit with one of the repellent compounds. The nine compounds tested were: ethyl propanoate, 2-methyl-1-propanol, diethyl carbonate, 2-methylpropanal, 3-methyl-1-butanol, ethyl 2-methylpropanoate, ethyl butanoate, ethyl (E)-but-2-enoate, and 3-methyl-3 buten-1-ol. In addition, flies were given a choice between untreated fruit and a blank control to determine their attraction to fruit in the absence of other odors. The lid of each arena had an 80 mm diameter circular hole covered with a nylon mesh (anti-thrips insect screen, mesh size: 81×81; BioQuip, CA, USA) to provide ventilation while retaining flies (FIG. 1C). Two gated traps consisting of polystyrene vials (same as described above), one containing a repellent compound and one containing nothing, were placed inside each arena with equal quantities (ca. 5 g) of blueberry fruit (n=5) (stored-bought and sterilized as described elsewhere herein) (FIG. 1C). Each pair of traps in each choice arena was wrapped with aluminum foil and sealed with Parafilm with a 4-mm-diameter hole in the center of the Parafilm to provide an entrance for the flies, as described above, and were placed vertically on opposite sides of the arenas. A vial with a cotton ball moistened with deionized water was placed in the center of each arena as a water source for the flies (FIG. 1C). Twenty D. suzukii (1:1 male: female ratio) were released inside each arena, and the number and sex of flies inside and outside the traps was counted after 24 h. All choice tests started at 1:00 p.m., were replicated 5 times, and were conducted under a fume hood at 22+2° C., 60±5% RH, and 16:8 (L:D) h.

8. Multiple Choice Bioassays #2: Comparing D. suzukii Responses to Known and Putative Anthracnose-Emitted Repellents

Additional multiple-choice assays, as described in Section 6, were conducted to compare the repellency of the two most effective repellents identified from anthracnose-infected fruit (ethyl butanoate and ethyl (E)-but-2-enoate; based on Results from Sections 6 and 7) with three known D. suzukii repellents (1-octen-3-ol, geosmin, and 2-pentylfuran). Within each arena, six gated traps were positioned randomly in a circle (40 cm diameter) at equal distance with each trap 20 cm apart along the circumference. Each gated trap contained ˜5 g of store-bought organic blueberry fruit (n=5), as described elsewhere herein. One of the six traps served as a control (with blueberry fruit only) and the remaining five traps had one of the repellents added to the blueberry fruit. Each volatile (50 μL, neat) was released from a 1 mL polyethylene vial with a piece of cotton placed inside each trap (control traps had vials with cotton but without the volatile). A vial with a cotton ball soaked with deionized water was placed in the middle of the arena. Roughly 150 D. suzukii adults (1:1 male: female ratio) were released inside each arena and the number and sex of flies inside treatment and control traps was recorded after 24 h. The experiment started at 1:00 p.m., was replicated 6 times, and was done in a laboratory under 22±2° C., 55±5% RH, 16:8 (L:D) h.

### 9. Statistical Analyses

### 9.1 Volatile Analyses

Statistical analyses of the volatile relative abundances were carried out in R version 3.6.1. Peak areas were normalized by berry weight. Composition among samples was visualized with a nonmetric multidimensional scaling (NMDS) based on Bray-Curtis dissimilarities. Volatile emission was further investigated with permutational analysis of variance (PERMANOVA) using time, inoculation treatment, and their interaction as effects with the adonis function in the vegan package. Dispersion in the dissimilarity matrix based on the volatile emission data was compared between treatments and among collection days using the betadisper function. Differences in volatile emission between anthracnose-infected and control fruit were investigated using differential analysis based on the negative binomial distribution (α=0.01). A linear model of total volatile emissions (sum of volatile peak area divided by blueberry sample weight) with fixed effects of time, treatment, and their interaction was used to investigate patterns of volatile emission in samples. Statistical significance for linear model parameters was determined using analysis of variance (ANOVA).

### 9.2 Behavioral Analyses

Data from multiple choice assays on the percent of male and female D. suzukii adults responding to each volatile were compared using ANOVA (Minitab version 17; Minitab Inc., State College, PA, USA). The ANOVA model included treatment, sex, and their interaction as fixed factors and block (replicate) as a random factor. A multi-comparison Tukey test (Minitab) was used to determine differences among treatments. Percent data were arcsine square-root transformed prior to ANOVA. Pairwise choice assays were analyzed using G-tests with William's correction. Non-responders were excluded from the statistical analyses.

### 10. Electroantennogram Experiments

Electroantennogram (EAG) assays were conducted to determine the antennal response of sexually mature male and female D. suzukii to ethyl butanoate, ethyl (E)-but-2-enoate, and 2-pentylfuran. The antennal responses of male and female D. suzukii to each compound were tested at five doses (0.001 mg, 0.01 mg, 0.1 mg, 1 mg, and 10 mg) diluted in hexane. The stimulus cartridge preparations, antennal preparations, and EAG apparatus used were similar to those previously described in the literature. Stimulus applicators consisted of a 14.5-cm-long glass Pasteur pipette containing 20 μL of each volatile dose (or hexane control) pipetted onto a 6×0.5-cm strip of filter paper. The applicators containing the impregnated filter paper were placed under the fume hood for 2 min to allow the hexane to evaporate. For the recording and base electrodes, a silver wire was inserted into a drawn capillary tube filled with phosphate-buffered saline (NaCl, 4 g; NA₂HPO₄, 0.57 g; KH₂PO₄, 0.1 g; KCl, 0.1 g in 500 ml distilled water). To attach the base electrode to the fly, the fly's abdomen was removed, and the sharp tip of the saline-filled capillary tube was pulled directly into the thoracic cavity. Once the fly preparation was mounted, the recording electrode was carefully moved toward the antenna using a micromanipulator until the antenna touched the pool of saline solution on the recording electrode. Antennal preparations were exposed to a constant stream of charcoal-filtered and humidified air at a rate of 1.5 l/min.

The EAG apparatus consisted of an IDAC-02 interface board for data acquisition and used Syntech software (Syntech Ltd., Hilversum, The Netherlands) for recording, storing, and quantifying EAG responses. Antennal preparations were primed with 1 mg of acetoin, a known attractant and antennally active compound, to ensure that the antennae were prepared correctly and responsive (positive control). Then, the antennae were exposed to a hexane control, followed by exposure to increasing doses of one of the volatiles. Each antenna was exposed to four rounds of each dose of a single compound before being discarded. Six antennae were tested daily: three from males and three from females. Test and control compounds were applied at 10 second(s) intervals at a pulse rate of 0.5 s, with a 1-min interval between each stimulus. Maximum amplitudes of depolarizations were measured (in millivolts) for each compound with the response from the hexane-only controls subtracted from the other doses to normalize the antennal response. In total, each dose of each compound was replicated 10 times for each sex.

### 11. Semi-Field Experiments

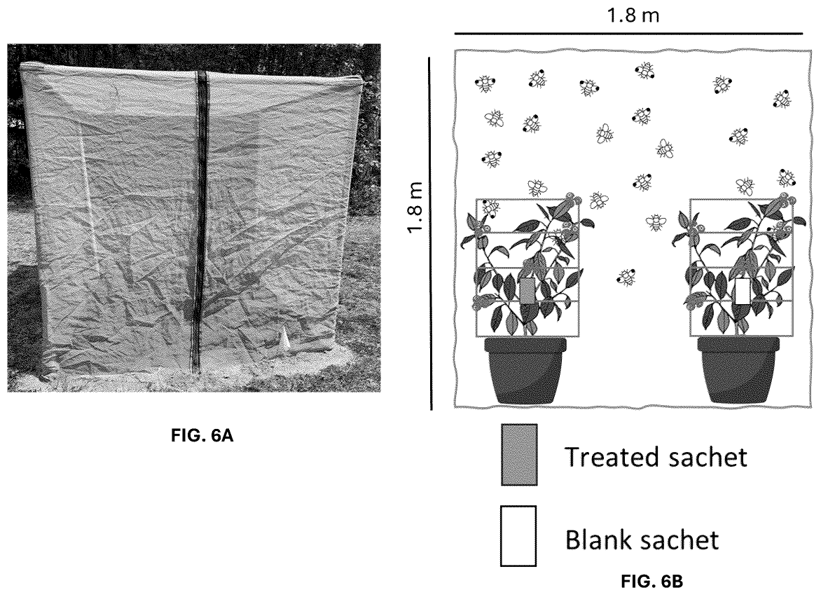

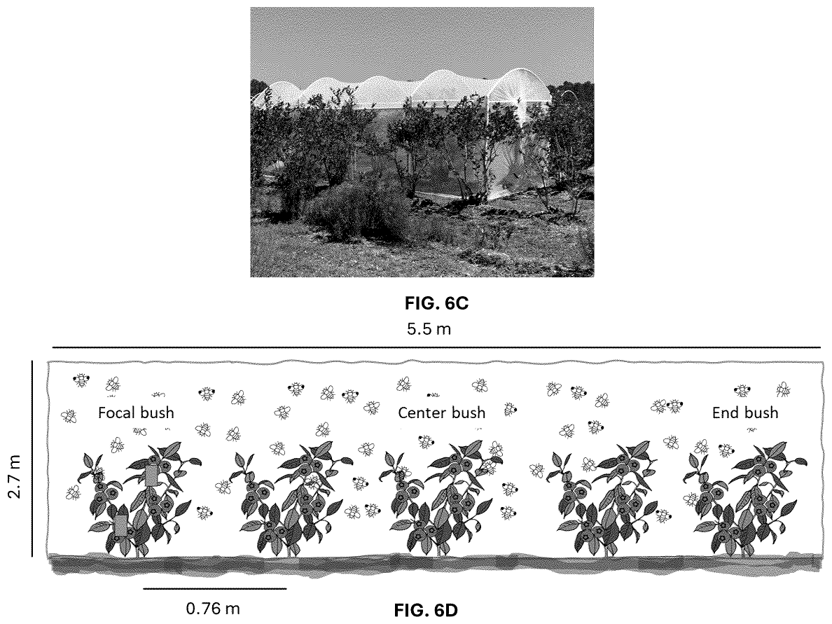

Semi-field cage experiments were conducted from June until July to evaluate the oviposition deterrent effects of ethyl butanoate, ethyl (E)-but-2-enoate, and 2-pentylfuran against D. suzukii. These experiments are considered semi-field because they took place in an isolated open field surrounded by woods with potted plants inside outdoor cages. The cages were constructed using polyvinyl chloride (PVC) pipes (3.8 cm diameter) to construct 1.8 m×1.8 m×1.8 m frames. Screen tents (Lumite® screen portable field cages; BioQuip, CA, USA) were placed over the PVC frames, and large nails were used to secure the tents to the ground (FIG. 6A). Cages were spaced 10 m apart.

To obtain blueberries for the experiment, prior to the start of the experiment, field-grown highbush blueberry (Vaccinium corymbosum L. var. ‘Bluecrop’) clusters were bagged early in the season with cloth bags when they were still green to prevent infestation from resident D. suzukii populations for use in the experiment. In addition, 80 3-to-4-year-old potted blueberry bushes were stripped of their berries and used for the experiment.

On the day of testing, two bushes were placed in each cage (FIG. 6B). Each bush in the tent was surrounded by a metal tomato cage. The bagged blueberry fruit clusters in the field were clipped and brought inside the cages. Clusters of 10 berries were created and placed in water picks. Five berry clusters were distributed randomly and evenly on each tomato cage at different heights using green twist ties (FIG. 6B). The sachets used for the treatments were prepared according to the methods described by Gale et al. (2024). They were constructed from 8 cm strips of polyethylene tubing (5.1 cm width, 2 MIL thickness; ULINE, Pleasant Prairie, WI, USA) and polyester felt (Grainger, Lake Forest, IL, USA). One end of the polyethylene tubing was sealed with an impulse sealer. A 5 cm strip of felt was placed inside the sachet's open end, and a 2.5 mL aliquot of each treatment was pipetted onto the felt. The open end was then sealed shut with the impulse sealer, entirely sealing the saturated felt. A hole was punched at the top of each sachet, away from the treatment area to avoid damaging the sealed section, and green twist ties were used to hang the sachets in the center of a bush (FIG. 6B). Before loading the sachets, the weights of the empty sachets were taken. The sachets were weighed again directly after loading with the compounds and then a final time after the 24-hour test period to measure the emission rates of each volatile.

In each cage, one of the bushes contained a sachet with the test volatile, while the other contained a blank sachet (control). Sachets were hung in the bushes 30 minutes prior to the start of experiments. Choice tests included: 1) control versus control; 2) control versus ethyl butanoate; 4) control versus ethyl (E)-but-2-enoate; and 4) control versus 2-pentylfuran. Fifty flies (1:1 male: female) were released in each cage at 18:00 hrs. After 24 hours, the berry clusters were collected and placed in 118 mL plastic cups. Berries were inspected under a dissection microscope for the number of eggs laid and were then incubated in 236.6 mL (8-oz) deli containers lined with two cotton pads on a laboratory bench at 22±2° C. and 55±5% relative humidity for two weeks to monitor for adult emergence. The study was replicated 10 times for each choice combination (N=4 choice combinations×2 bushes each×10 replicates=total of 80 bushes; N=50 flies×4 choice combinations×10 replicates=total of 2,000 flies).

### 12. Field Experiments

Field cage experiments were conducted from June until July using highbush blueberries (V. corymbosum var. ‘Bluecrop’). The studies were carried out in 5.5 m long×2.7 m tall cages, constructed with a PVC pipe frame covered with No-See-Um mesh (Quest Outfitters Inc., Sarasota, FL, USA) (FIG. 6C). Cages were placed in separate rows within a blueberry field, with bushes spaced approx. 0.76 m apart within the rows and 3.05 m between rows. Each row contained two cages at least 9 m in distance. To avoid interference between treatments, alternate cages were used during testing, ensuring that no adjacent cages contained sachets simultaneously.

Two, 3-m rebar poles were used to reinforce the mesh on the long sides of each cage as well as 10 cm long garden staples to hold mesh flush to the ground, while the shorter ends were secured with clips to allow access to the cage. Each cage contained five blueberry bushes approx. 1.5 m in height. Sachets containing ethyl butanoate, ethyl (E)-but-2-enoate, or 2-pentylfuran were prepared as described before. To test the effects of the repellents on the treated (focal) bush and in neighboring bushes at various distances, two sachets of the same compound were hung from one of the end bushes in each cage (FIG. 6D). There were four treatments: 1) ethyl butanoate, 2) ethyl (E)-but-2-enoate, 3) 2-pentylfuran, and 4) control (no repellent). Each treatment was replicated four times, with each cage assigned to a single treatment, resulting in a total of 16 cages.

Twenty-four hours after deploying the sachets, 120 flies (approximately 60 males and 60 females) were released into each cage at 18:00 hrs (N=120 flies×4 treatments×4 replicates=1,920 total flies). To ensure even distribution within the cages, 30 flies were released at four equidistant points between the bushes. A pre-sampling of the berries, conducted before the flies were released, confirmed the absence of any infestation. Berries were then collected 1-, 2-, and 3-days post-treatment. From every other bush (starting at the focal bush) in the cage, 50 berries from the top half and 50 from the bottom half were collected into two separate 236.6 mL deli containers lined with two cotton pads. From each berry sample, a random subsample of 10 berries were examined and egg counts recorded before being returned to the original container. The blueberries were incubated on a light bench in the laboratory for up to two weeks, as previously described, and adult emergence was recorded. The sachets were weighed before deployment and 3 days after deployment to measure the emission rates of each compound.

### 13. Statistical Analysis

To analyze the effect of dose of the three repellents on D. suzukii antennal responses, a generalized linear model (GLM) was used with a Poisson distribution and a log link function in SPSS Statistics 23.0 (IBM Corp, Armonk, NY, USA). The model included ‘Treatment’ (ethyl butanoate, ethyl (E)-but-2-enoate, and 2-pentylfuran), ‘Dose’, ‘Sex’, and their interactions as independent variables. This analysis, when significant, was followed by post hoc Bonferroni tests (α=0.05) to determine individual differences among groups. Prior to analysis, EAG data were normalized relative to the response to the hexane control.

Semi-field cage data were analyzed using paired t-tests to determine differences between the number of eggs laid and adults that emerged from treated berries compared to control berries, and survival data were analyzed using two-way analysis of variance (ANOVA) (R statistical software version 4.1.1; R Development Core Team, Vienna, Austria). In addition, a deterrence index (DI) was calculated for each treatment as follows:

$$DI = \frac{( {n}_{control} - {n}_{volatile} )}{{n}_{total}}$$

Where n_{control}, nᵥₒₗₐₜᵢₗₑ, and nₜₒₜₐₗ are the number of eggs laid in the control fruits, treatment fruits, and total number of eggs laid in the control and treatment fruits, respectively. The DI values were compared among treatments using ANOVA (R statistical software). Before the analysis, data were checked for normality and equal variance using an Anderson-Darling test and Levene's test, respectively.

Field cage data for both oviposition and adult emergence were non-normal, so non-parametric tests were applied using R statistical software. The effects of ‘Treatment’ (untreated control, ethyl butanoate, ethyl (E)-but-2-enoate, and 2-pentylfuran) across ‘Bush Position’ (focal, center, end) and ‘Day After Treatment’ (1, 2, 3 DAT) were assessed using the Kruskal-Wallis Test. When significant Treatment effects were found, post-hoc separation was performed using Dunn's Test. Initial analyses showed no significant differences in oviposition or adult emergence based on location on the bush (top vs. bottom); therefore, the data were averaged and analyzed at the bush level.

Finally, the emission rates of compounds in the semi-field and field cage studies were calculated by subtracting the final weight of the sachets from the initial weight and dividing by the time interval (24 h or 3 days). These rates were then compared across repellent treatments using ANOVA, with Tukey pairwise comparisons conducted when significant differences were found.

### Results

### 1. Volatile Analysis

For all samples and treatments, a total of 63 volatiles were detected (Table 2) including many compounds that have been previously reported in blueberry and fungal headspace. Chemical classes detected include various esters, alcohols, monoterpenes, monoterpenoids, benzenoids, aldehydes, a sesquiterpene, and a carboxylic acid. Esters were the most frequently detected compound class.

Ordination of sample data via NMDS revealed a high degree of similarity among the five C. fioriniae strains used to infect fruit in the laboratory. Because of this similarity, all samples inoculated with the pathogen were subsequently analyzed as a single group, i.e., infected vs. uninfected or control.

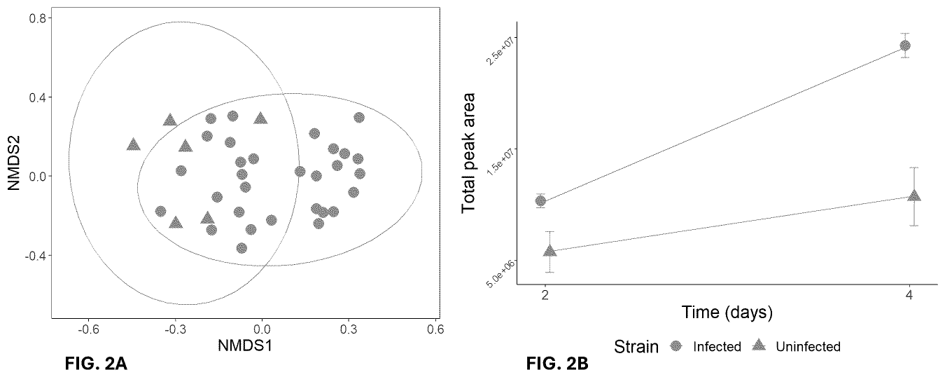

Volatile emission differed between infected and control samples as visualized with NMDS (FIG. 2A) and further confirmed via PERMANOVA results (treatment: F_{1,32}=20.1; P<0.001). Time (F_{1,32}=49.7; P<0.001) and the interaction between time and treatment (F_{1,32}=6.4; P=0.01) were also significant. Total volatile emission was higher in infected than control fruit (treatment: F_{1,32}=34.5; P<0.001) and increased over time for both control and infected fruit (time: F_{1,32}=117; P<0.001; FIG. 2B), although a significant interaction between time and treatment (timextreatment: F_{1,32}=8.45; P=0.006) indicated that total volatile emission rose more rapidly in infected vs. control fruit over time.

Differences between anthracnose-infected and control fruit were driven by higher emission of 14 volatiles, listed in Table 2 in bold font. They include an aldehyde (2-methylpropanal or isobutyraldehyde), a benzenoid (styrene), 5 alcohols (2-methyl-1-propanol, 3-methyl-1-propanol, 2-methyl-1-butanol, 3-methyl-3-buten-1-ol, (E)-2-hexen-1-ol), a ketone (3-hydroxy-2-butanone or acetoin), and 6 esters (ethyl propanoate, ethyl 2-methylpropanoate, ethyl butanoate, diethyl carbonate, ethyl (E)-but-2-enoate, ethyl 3-hydroxy-3-methylbutanoate). All 14 volatiles which differed between infected and control fruit were identified with a commercially available standard on two GC columns. No volatiles were found at higher quantities in control fruit headspace.

To confirm that experimentally-infected berries exhibited field realistic volatile emissions, infected and uninfected berries collected from the field were also analyzed. The 14 compounds identified in experimentally-infected fruit were also found to be elevated in the field-collected fruit (Table 2). Because field-collected fruit were riper and at a more advanced stage of infection than the experimentally-infected berries, field-collected fruit tended to have higher volatile emission regardless of infections status. Experimentally-infected fruit showed no visual signs of infection on day 2 and only subtle cues on day 4, whereas field fruit were identified as infected by visual cues. NMDS ordination of the field and lab collected fruit further indicated good agreement between experimental and field fruit.

2.Multiple Choice Bioassays #1: Comparing D. suzukii Responses to Anthracnose-Induced Volatiles

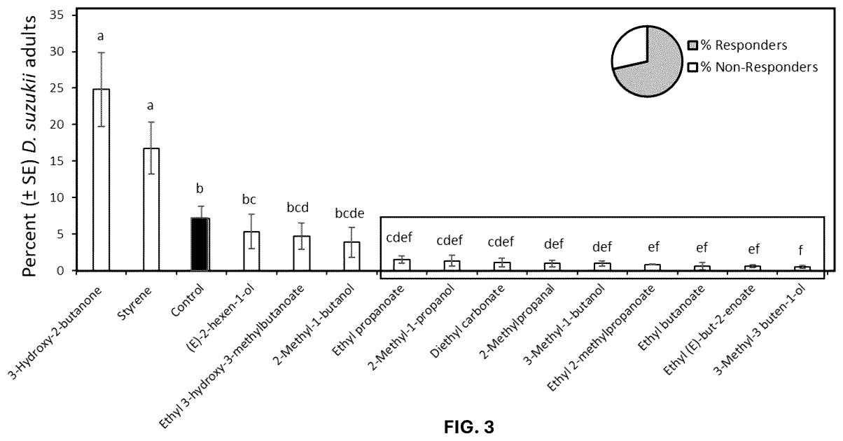

The 14 volatiles identified as more abundant in the headspace of infected berries were compared for their capacity to repel D. suzukii in a multi-choice bioassay. The behavioral response of D. suzukii adults was affected by treatment (F_{14,87}=15.92; P<0.001) and sex (F_{1,87}=5.51; P=0.021) but not by the interaction between treatment and sex (F_{14,87}=0.39; P=0.975), indicating that the effect of treatment was not influenced by sex. In the multiple-choice assay, nine volatiles reduced the number of flies captured relative to the control (FIG. 3): ethyl propanoate, 2-methyl-1-propanol, diethyl carbonate, 2-methylpropanal, 3-methyl-1-butanol, ethyl 2-methylpropanoate, ethyl butanoate, ethyl (E)-but-2-enoate, and 3-methyl-3-buten-1-ol. Three volatiles captured a similar number of flies as the control (2-methyl-1-butanol, (E)-2-hexen-1-ol, ethyl 3-hydroxy-3-methylbutanoate) and two compounds trapped a higher number of flies than the control (3-hyrdroxy-2-butanone, styrene). The response of females to these volatiles was 30% stronger than males.

3. Pairwise Choice Bioassays: Evaluating D. suzukii Response to Putative Anthracnose-Emitted Repellents

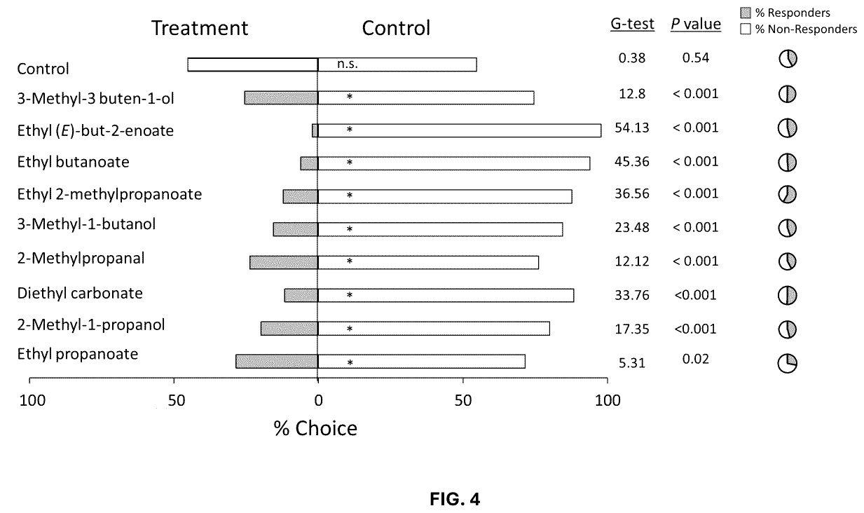

The nine volatiles screened in the multi-choice assay were then tested in dual choice bioassays. All nine showed significant repellency (FIG. 4). The two most repellent compounds were ethyl (E)-but-2-enoate and ethyl butanoate (≥90% repellency), followed by diethyl carbonate, ethyl 2-methylpropanoate, and 3-methyl-1-butanol (≥80% repellency). Both sexes responded similarly to all compounds.

4. Multiple Choice Bioassays #2: Comparing D. suzukii Responses to Known and Putative Anthracnose-Emitted Repellents

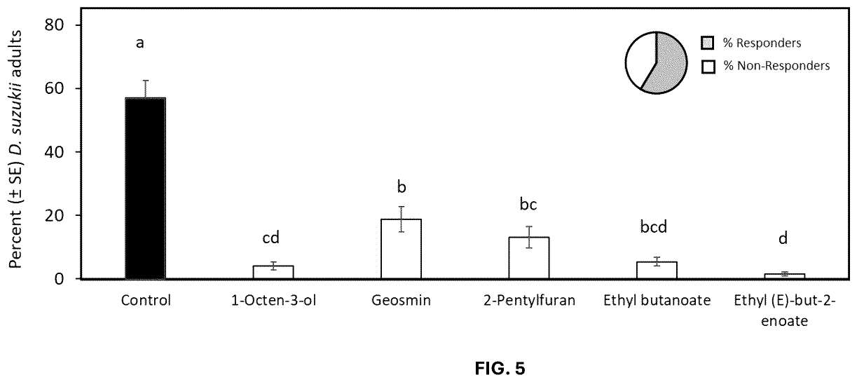

The two most repellent compounds were ethyl (E)-but-2-enoate and ethyl butanoate were compared with 1-octen-3-ol, geosmin, and 2-pentylfuran for their capacity to repel D. suzukii in a multi-choice bioassay. The behavioral response of D. suzukii adults was affected by treatment (F_{5,55}=29.69; P<0.001) but not by sex (F_{1,55}=0.1; P=0.756) or by the interaction between treatment and sex (F_{5,55}=0.65; P=0.663), indicating that the effect of treatment was not influenced by sex. In the multiple-choice assay, all five repellents reduced the number of flies captured relative to the control (FIG. 5); however, there were differences in the strength of repellency among them. Ethyl (E)-but-2-enoate was the most repellent, followed by 1-octen-3-ol and ethyl butanoate, while geosmin and 2-pentylfuran were the least repellent (FIG. 5).

### 5. Electroantennogram Experiments

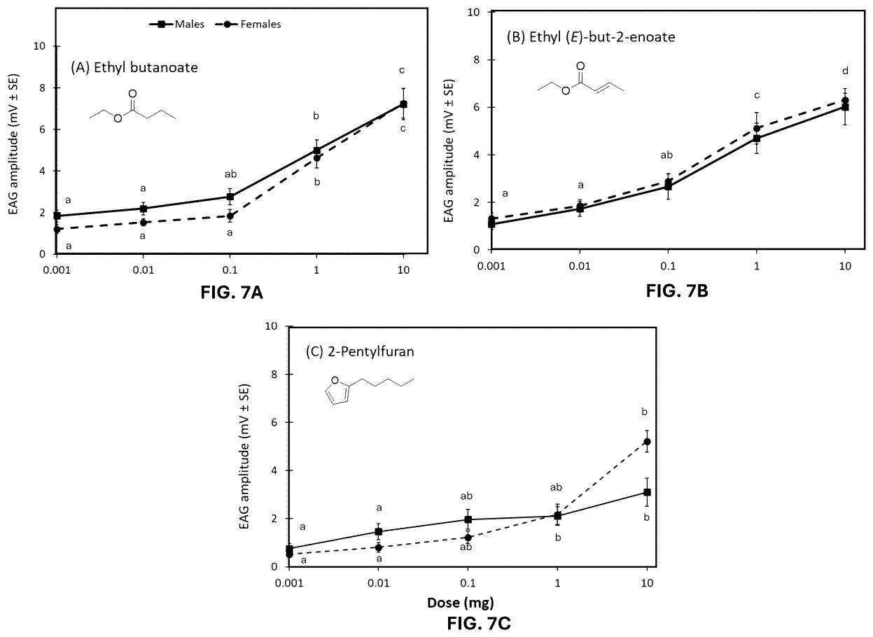

Both male and female D. suzukii exhibited dose-dependent antennal responses to ethyl butanoate, ethyl (E)-but-2-enoate, and 2-pentylfuran (Table 3; FIGS. 7A-7C). The strength of the EAG responses varied among treatments, with ethyl butanoate and ethyl (E)-but-2-enoate eliciting stronger antennal responses than 2-pentylfuran (Table 3; FIGS. 7A-7C). There was no significant effect of sex on the antennal responses to these compounds, nor was there a significant interaction between treatment and sex (Table 3), indicating that the antennal responses of male and female D. suzukii to ethyl butanoate, ethyl (E)-but-2-enoate, and 2-pentylfuran were similar. Although the EAG responses increased with rising doses of the compounds, the antennae of D. suzukii responded more strongly to ethyl butanoate and ethyl (E)-but-2-enoate than to 2-pentylfuran at higher doses (FIGS. 7A-7C), as indicated by the significant treatment-by-dose interaction (Table 3).

TABLE 3
Exemplary results of generalized linear model (GLM)^{a}

| Source of Variation | Wald χ² | df | P value^{b} |
|---|---|---|---|
| (Intercept) | 1578.21 | 1 | <0.001 |
| Treatment | 91.72 | 2 | <0.001 |
| Dose | 477.87 | 4 | <0.001 |
| Sex | 0.05 | 1 | 0.817 |
| Treatment × Dose | 67.78 | 8 | <0.001 |
| Treatment × Sex | 5.21 | 2 | 0.074 |
| Dose × Sex | 1.89 | 4 | 0.754 |
| Treatment × Dose × Sex | 1.16 | 8 | 0.997 |

^{a}Effects of treatment: ethyl butanoate, ethyl (E)-but-2-enoate, and 2-pentylfuran); Significant P values in bold, dose, sex, and their interactions on the electroantennogram (EAG) for Drosophila suzukii.

### 6. Semi-Field Experiments

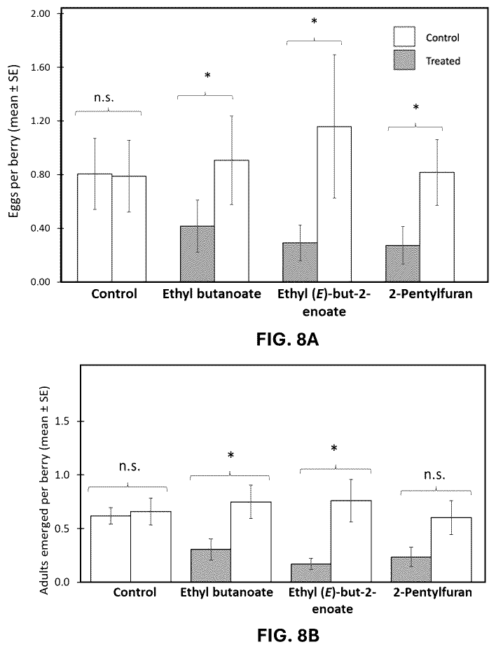

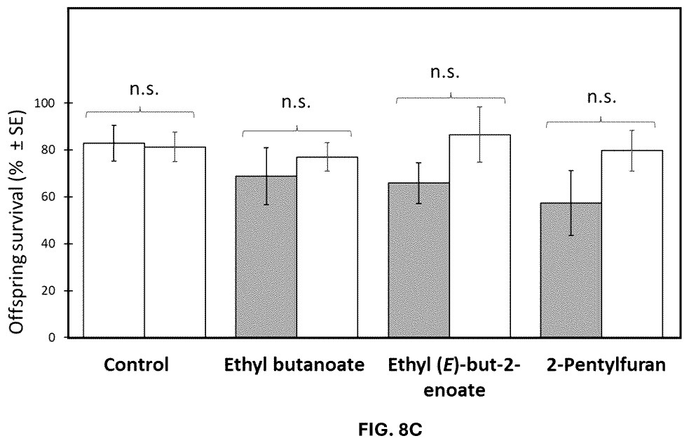

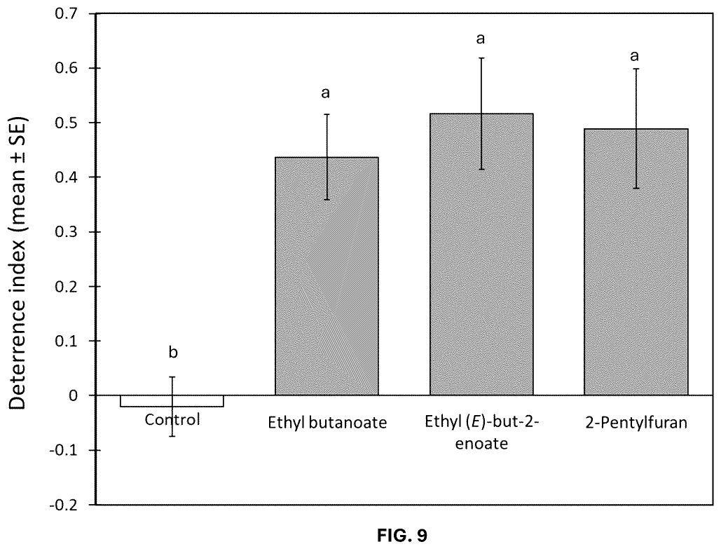

Semi-field cage assays using potted blueberry plants were used to test the efficacy of ethyl butanoate, ethyl (E)-but-2-enoate, and 2-pentylfuran on D. suzukii oviposition. There were no differences in the emission rates of the three compounds (F=1.66; df=2,12; P=0.231; mean emission rates (±SE) were 70.4±14.2 mg/h for ethyl butanoate, 54.9±8.9 mg/h for ethyl (E)-but-2-enoate, and 82.3±7.6 mg/h for 2-pentylfuran). Drosophila suzukii consistently laid fewer eggs in berries paired with the treatments in comparison to control berries (FIG. 8A). Flies laid 54% fewer eggs in ethyl butanoate-treated berries (t=2.29, P=0.047), 75% fewer berries in ethyl (E)-but-2-enoate treated berries (t=3.76, P=0.005), and 67% fewer eggs in 2-pentylfuran treated berries (FIG. 8A).

When comparing the emergence of adult progeny (FIG. 8B), more flies emerged from the control berries compared to the berries treated with the two anthracnose-associated compounds, with 59% fewer flies emerging from ethyl butanoate treated berries (t=4.07, P=0.003) and 78% fewer flies emerging from ethyl (E)-but-2-enoate treated berries (t=2.81, P=0.02). The difference in adult emergence between untreated berries and 2-pentylfuran treated berries was nonsignificant (t=2.06, P=0.069).

The percentage of eggs that survived to adulthood ranged from 57% (+14%) to 83% (+8%) across all treatments (FIG. 8C). A two-way ANOVA showed no significant differences in offspring survival among the treatments or between treatments and controls (all P values >0.05), indicating that the treatments only affected D. suzukii oviposition behavior which resulted in reduced adult emergence.

After calculating the DI based on the number of eggs laid within each cage, ethyl butanoate, ethyl (E)-but-2-enoate, and 2-pentylfuran all performed similarly and were significantly different from the control (F=4.85; df=4,36; P=0.005) (FIG. 9).

### 7. Field Experiments

Field cage assays using cultivated blueberry bushes tested the efficacy of ethyl butanoate, ethyl (E)-but-2-enoate, and 2-pentylfuran on D. suzukii oviposition. In these trials, the emission rates differed significantly among the three tested compounds (F=16.29; df=2,27; P<0.001). The emission rates for ethyl butanoate (mean±SE=697.97+7.96 mg/day) and ethyl (E)-but-2-enoate (679.23+17.73 mg/day) were significantly higher than those for 2-pentylfuran (559.73+23.54 mg/day).

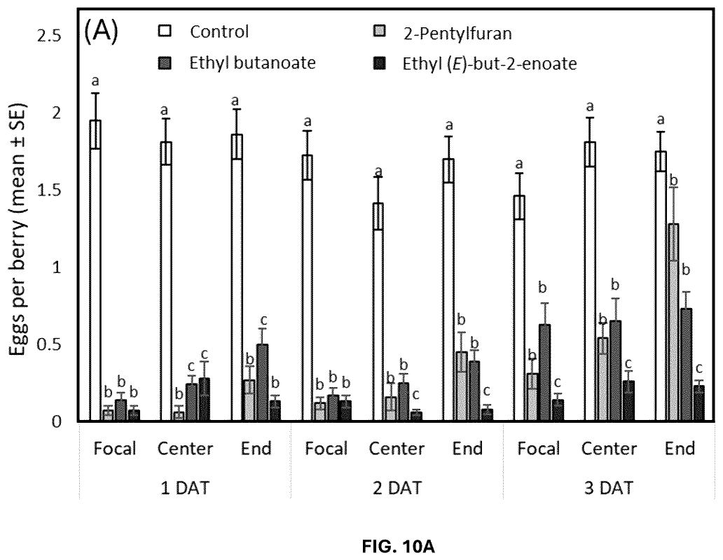

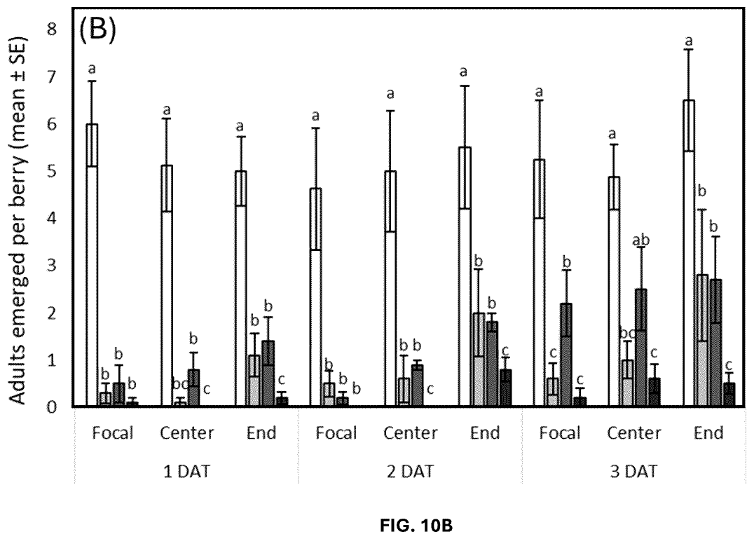

Egg counts were higher in the control than all the treatment groups regardless of bush position or DAT (FIG. 10A). Among the three repellent treatments, the response varied depending on the bush position and DAT. At 1 DAT, all repellent treatments reduced egg counts in the focal bush compared to the control (χ²=222.01; df=3; P<0.001), but there were no differences among them; 2-pentylfuran was lower at the central bush (χ²=206.70; df=3, P<0.001); and 2-pentylfuran and ethyl (E)-but-2-enoate had the fewest eggs at the end bush (χ²=143.43, df=3, P<0.001) (FIG. 10A). At 2 DAT, the treatments again demonstrated similar oviposition repellency at the focal bush (χ²=174.37; df=3; P<0.001), but ethyl (E)-but-2-enoate had the lowest egg counts at both the center (χ²=151.81; df=3; P<0.001) and the end bush (χ²=148.01; df=3; P<0.001) (FIG. 10A). By 3 DAT, ethyl (E)-but-2-enoate had the lowest egg count at all three bushes sampled (focal: χ²=91.26; df=3; P<0.001; center: χ²=91.31; df=3; P<0.001; end: χ²=85.12; df=3; P<0.001) (FIG. 10A).

The emergence of adult progeny was also higher in the untreated control cages than any of the repellent treatments (FIG. 10B). At 1 DAT and 2 DAT, there were differences in adult emergence between the control and all the repellent treatments at the focal bush (1 DAT: χ²=25.01; df=3; P<0.001; 2 DAT: χ²=25.48; df=3; P<0.001) but no differences among them; ethyl (E)-but-2-enoate had the fewest adults emerge at the center (1 DAT: χ²=25.48; df=3; P<0.001; 2 DAT: χ²=23.20; df=3; P<0.001) and end bush (1 DAT: χ²=19.56; df=3; P<0.001; 2 DAT: χ²=14.94; df=3; P<0.001) (FIG. 10B). At 3 DAT, 2-pentylfuran and ethyl (E)-but-2-enoate had the lowest adult emergence at the focal (χ²=19.20; df=3; P<0.001) and center bush (χ²=15.72; df=3; P<0.001) but, at the end bush, only ethyl (E)-but-2-enoate was significantly different compared to the other repellents (χ²=15.35; df=3; P<0.001) (FIG. 10B).

### 8. Selected Results

This study demonstrated that: 1) both male and female antennae of D. suzukii can detect ethyl butanoate, ethyl (E)-but-2-enoate, and 2-pentylfuran in a dose-dependent manner; and 2) these repellent compounds reduce D. suzukii oviposition and adult emergence in blueberry fruits under semi-field and field conditions.

After anthracnose-infected blueberries were found to repel D. suzukii, it was found that 14 volatiles emitted at higher levels in infected berries compared to healthy ones for their repellent activity against this pest in laboratory studies. It has been shown that nine of these volatiles had repellent properties. Among them, two esters, ethyl butanoate and ethyl (E)-but-2-enoate, showed the strongest repellent effects, and as demonstrated in this study, these compounds also trigger strong dose-dependent antennal responses in adult D. suzukii and act as oviposition deterrents under semi-field and field conditions. These compounds are naturally present in the headspace of blueberries and are mainly associated with fruit ripening. Since anthracnose infections cause rapid ripening and collapse of the fruit, the emission rate of these volatiles increases. Given that D. suzukii are typically attracted to ripening or ripe fruits for oviposition rather than overripe ones, the observed oviposition deterrent effects in this study may indicate that the flies perceive the fruits as beginning to rot, thus discouraging them from laying eggs.

Ethyl butanoate has been previously identified as an antennally active compound in D. suzukii and shown to reduce attraction to lures. However, its role as an oviposition deterrent under field conditions had not been confirmed until this study. Ethyl (E)-but-2-enoate, while structurally similar to ethyl butanoate, has also not been previously identified as an oviposition deterrent. Both compounds elicited similar dose-dependent responses in EAG assays for both male and female D. suzukii. However, when compared to the known repellent 2-pentylfuran, these esters showed comparable or stronger antennal detection efficacy, especially at higher doses. A similar trend was observed in the semi-field cage studies, where ethyl butanoate, ethyl (E)-but-2-enoate, and 2-pentylfuran significantly reduced D. suzukii oviposition in treated berries compared to the control. In the field cage studies, ethyl (E)-but-2-enoate tended to outperform both ethyl butanoate and 2-pentylfuran, particularly at longer distances from the focal plant and after at least three days of deployment, demonstrating greater oviposition deterrent activity.

It has been demonstrated that only female D. suzukii were repelled or deterred from ovipositing by volatiles from anthracnose-infected fruits, likely because they are searching for suitable oviposition sites. Anthracnose infection likely reduces the quality of fruits for D. suzukii offspring development, showing a positive relationship between female oviposition preference and offspring performance. However, when examining the antennal response of D. suzukii to ethyl butanoate and ethyl (E)-but-2-enoate, both males and females showed similar responses, indicating that both sexes can detect these compounds. Although males may be less behaviorally responsive to anthracnose-infected fruits than females, both male and female D. suzukii were found to be repelled by these compounds in laboratory assays (Rering et al. 2023). The role of these volatiles in influencing male behaviors remains unclear.

It is contemplated herein that ethyl butanoate and ethyl (E)-but-2-enoate synergize with other known D. suzukii repellents, such as 2-pentylfuran, geosmin, and 1-octen-3-ol, as well as other repellent compounds found in anthracnose-infected blueberries. Combining these compounds could help maintain their repellent efficacy in the field, especially since ethyl butanoate and ethyl (E)-but-2-enoate are more volatile than other known D. suzukii repellents. Further research is also needed to identify optimal deployment methods for these compounds. In the field cage study, ethyl butanoate and ethyl (E)-but-2-enoate exhibited higher emission rates than 2-pentylfuran, with minimal amounts remaining in the sachets after 3 days. Employing slow-release technologies, such as the inert matrix SPLAT® (Specialized Pheromone and Lure Application Technology), aerosol diffusers, and nanoencapsulation, could help sustain adequate emission rates of these compounds in the field.

Previously, repellents against D. suzukii have shown some success in reducing infestations in raspberries in both greenhouse and field studies. However, repellents alone are typically insufficient to fully eradicate D. suzukii infestations, which is critical in crops like blueberries where there is zero tolerance for infested fruit. Nonetheless, repellent or oviposition deterrent compounds can be valuable tools when used in combination with other behavioral manipulation methods. For example, they could be paired with attract-and-kill devices to develop push-pull systems for D. suzukii. Push-pull systems work by using a repellent or oviposition deterrent to “push” the pest away from the target crop, while the “pull” component attracts pests to a kill device. Thus, in one aspect, the disclosure contemplates exemplary push-pull systems, including but not limited to a push-pull systems using 1-octen-3-ol or methyl benzoate as the push component, combined with an attract-and-kill device as the pull component, for managing D. suzukii in raspberries and blueberries.

In conclusion, the current study identified the esters ethyl butanoate and ethyl (E)-but-2-enoate, derived from pathogen-infected fruit, as promising oviposition deterrents for D. suzukii. While previous studies have shown that pathogen infections and isolated compounds can repel D. suzukii and deter oviposition, the physiological and behavioral effects of specific compounds remained largely unexplored. In this study, ethyl butanoate and ethyl (E)-but-2-enoate elicited dose-dependent antennal responses in D. suzukii and significantly reduced oviposition and adult emergence in semi-field and field trials, performing comparably to, or sometimes even better than, the known D. suzukii repellent, 2-pentylfuran. Further research is necessary to evaluate the spatial and temporal efficacy of these compounds, as well as optimal deployment methods, under more realistic field conditions with natural levels of pest pressure. Additionally, their repellent effects on other pests, as well as their compatibility with other D. suzukii management tactics such as biological control, need to be explored. Nevertheless, the strong antennal responses and oviposition deterrent effects observed suggest that these compounds could serve as valuable tools for managing D. suzukii behavior in the field.

The terms and expressions employed herein are used as terms of description and not of limitation, and there is no intention in the use of such terms and expressions of excluding any equivalents of the features shown and described or portions thereof, but it is recognized that various modifications are possible within the scope of the embodiments of the present application. Thus, it should be understood that although the present application describes specific embodiments and optional features, modification and variation of the compositions, methods, and concepts herein disclosed may be resorted to by those of ordinary skill in the art, and that such modifications and variations are considered to be within the scope of embodiments of the present application.

### Enumerated Embodiments

The following enumerated embodiments are provided, the numbering of which is not to be construed as designating levels of importance:

The following enumerated embodiments are provided, the numbering of which is not to be construed as designating levels of importance:

Embodiment 1 provides a composition consisting essentially of: about 1 to about 50% (v/v) of ethyl butanoate and (E)-ethyl but-2-enoate; and at least one suitable agriculturally-acceptable additive, wherein the ethyl butanoate and (E)-ethyl but-2-enoate are present in a ratio of about 1:1, 1:2, 1:3, 1:4, 1:5, 1:6, 1:7, 1:8, 1:9, 9:1, 8:1, 7:1, 6:1, 5:1, 4:1, 3:2, or 2:1 of ethyl butanoate: (E)-ethyl but-2-enoate.

Embodiment 2 provides the composition of embodiment 1, wherein the at least one suitable agriculturally-acceptable additive comprises a liquid carrier.

Embodiment 3 provides the composition of any one of embodiments 1-2, wherein the liquid carrier comprises/is a petroleum solvent, mineral oil, vegetable oil, or a mixture thereof.

Embodiment 4 provides the composition of any one of embodiments 1-3, wherein the ethyl butanoate and (E)-ethyl but-2-enoate are present in a ratio of about 1:1.

Embodiment 5 provides a method of repelling a Drosophila species fly from an agricultural crop, the method comprising placing a repellent composition on or next to at least one plant in the agricultural crop. In certain embodiments, the Drosophila species fly is Drosophila suzukii. In certain embodiments, the repellent composition consists essentially of: about 1 to about 50% (v/v) of ethyl butanoate and optionally about 1 to about 50% (v/v) of (E)-ethyl but-2-enoate; or about 1 to about 50% (v/v) of (E)-ethyl but-2-enoate and optionally about 1 to about 50% (v/v) of ethyl butanoate; and at least one suitable agriculturally-acceptable additive. In certain embodiments, the repellent composition consists essentially of at least one suitable agriculturally-acceptable additive and at least one of: about 1 to about 50% (v/v) of ethyl butanoate and about 1 to about 50% (v/v) of (E)-ethyl but-2-enoate.

Embodiment 6 provides the method of embodiment 5, wherein the repellent composition consists essentially of: about 1 to about 50% (v/v) of ethyl butanoate and (E)-ethyl but-2-enoate; and at least one suitable agriculturally-acceptable additive, wherein the ethyl butanoate and (E)-ethyl but-2-enoate are present in a ratio of about 1:1, 1:2, 1:3, 1:4, 1:5, 1:6, 1:7, 1:8, 1:9, 9:1, 8:1, 7:1, 6:1, 5:1, 4:1, 3:2, or 2:1 of ethyl butanoate: (E)-ethyl but-2-enoate.

Embodiment 7 provides the method of any one of embodiments 5-6, wherein the repellent composition is contained in a chemical propagator.

Embodiment 8 provides the method of any one of embodiments 5-7, wherein the chemical propagator is attached directly to at least one individual plant in the agricultural crop.

Embodiment 9 provides the method of any one of embodiments 5-8, wherein the agricultural crop is at least one of apples, oranges, peaches, grapes, pineapples, cherries, pears, guava, melon, banana, raspberries, blueberries, strawberries, or blackberries.

Embodiment 10 provides the method of any one of embodiments 5-9, further comprising placing on or next to at least one plant in the agricultural crop an attractive substance that attracts the Drosophila species fly (e.g., Drosophila suzukii).

Embodiment 11 provides the method of any one of embodiments 5-10, which repels or prevents at least 90% of Drosophila species flies (e.g., Drosophila suzukii) from eating, mating on, or laying eggs on the agricultural crop.

Embodiment 12 provides the method of any one of embodiments 5-11, wherein the attractive substance is in a trap that prevents at least one Drosophila species fly (e.g., Drosophila suzukii) from escaping.

Embodiment 13 provides a method of suppressing or reducing oviposition of a Drosophila species fly on an agricultural crop, the method comprising placing a repellent composition on or next to at least one plant in the agricultural crop. In certain embodiments, the Drosophila species fly is Drosophila suzukii. In certain embodiments, the repellent composition consists essentially of: about 1 to about 50% (v/v) of ethyl butanoate and optionally about 1 to about 50% (v/v) of (E)-ethyl but-2-enoate; or about 1 to about 50% (v/v) of (E)-ethyl but-2-enoate and optionally about 1 to about 50% (v/v) of ethyl butanoate; and at least one suitable agriculturally-acceptable additive. In certain embodiments, the repellent composition consists essentially of at least one suitable agriculturally-acceptable additive and at least one of: about 1 to about 50% (v/v) of ethyl butanoate and about 1 to about 50% (v/v) of (E)-ethyl but-2-enoate.

Embodiment 14 provides the method of embodiment 13, wherein the repellent composition consists essentially of about 1 to about 50% (v/v) of ethyl butanoate and (E)-ethyl but-2-enoate; and at least one suitable agriculturally-acceptable additive, wherein the ethyl butanoate and (E)-ethyl but-2-enoate are present in a ratio of about 1:1, 1:2, 1:3, 1:4, 1:5, 1:6, 1:7, 1:8, 1:9, 9:1, 8:1, 7:1, 6:1, 5:1, 4:1, 3:2, or 2:1 of ethyl butanoate: (E)-ethyl but-2-enoate.

Embodiment 15 provides the method of any one of embodiments 13-14, wherein the repellent composition is contained in a chemical propagator.

Embodiment 16 provides the method of any one of embodiments 13-15, wherein the chemical propagator is attached directly to at least one individual plant in the agricultural crop.

Embodiment 17 provides the method of any one of embodiments 13-16, wherein the agricultural crop is at least one of apples, oranges, peaches, grapes, pineapples, cherries, pears, guava, melon, banana, raspberries, blueberries, strawberries, or blackberries.

Embodiment 18 provides the method of any one of embodiments 13-17, further comprising placing on or next to at least one plant in the agricultural crop an attractive substance that attracts Drosophila species fly (e.g., Drosophila suzukii).

Embodiment 19 provides the method of any one of embodiments 13-18, which repels or prevents at least 90% of Drosophila suzukii flies from eating, mating on, or laying eggs on the agricultural crop.

Embodiment 20 provides the method of any one of embodiments 13-19, wherein the attractive substance is a trap that prevents at least one Drosophila species fly (e.g., Drosophila suzukii) fly from escaping.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

The contents of the articles, patents, and patent applications, and all other documents and electronically available information mentioned or cited herein, are hereby incorporated by reference in their entirety to the same extent as if each individual publication was specifically and individually indicated to be incorporated by reference. Applicants reserve the right to physically incorporate into this application any and all materials and information from any such articles, patents, patent applications, or other physical and electronic documents.

In sum, while this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A composition consisting essentially of:
about 1 to about 50% (v/v) of ethyl butanoate and (E)-ethyl but-2-enoate; and
at least one suitable agriculturally-acceptable additive,
wherein the ethyl butanoate and (E)-ethyl but-2-enoate are present in a ratio of about 1:1, 1:2, 1:3, 1:4, 1:5, 1:6, 1:7, 1:8, 1:9, 9:1, 8:1, 7:1, 6:1, 5:1, 4:1, 3:2, or 2:1 of ethyl butanoate: (E)-ethyl but-2-enoate.

2. The composition of claim 1, wherein the at least one suitable agriculturally-acceptable additive comprises a liquid carrier.

3. The composition of claim 2, wherein the liquid carrier comprises/is a petroleum solvent, mineral oil, vegetable oil, or a mixture thereof.

4. The composition of claim 1, wherein the ethyl butanoate and (E)-ethyl but-2-enoate are present in a ratio of about 1:1.

5. A method of repelling a Drosophila species fly from an agricultural crop, the method comprising:
placing a repellent composition on or next to at least one plant in the agricultural crop, wherein the repellent composition consists essentially of at least one suitable agriculturally-acceptable additive and:
about 1 to about 50% (v/v) of ethyl butanoate and optionally about 1 to about 50% (v/v) of (E)-ethyl but-2-enoate; or
about 1 to about 50% (v/v) of (E)-ethyl but-2-enoate and optionally about 1 to about 50% (v/v) of ethyl butanoate.

6. The method of claim 5, wherein the Drosophila species fly is Drosophila suzukii.

7. The method of claim 5, wherein the repellent composition consists essentially of:
about 1 to about 50% (v/v) of ethyl butanoate and (E)-ethyl but-2-enoate; and
at least one suitable agriculturally-acceptable additive,
wherein the ethyl butanoate and (E)-ethyl but-2-enoate are present in a ratio of about 1:1, 1:2, 1:3, 1:4, 1:5, 1:6, 1:7, 1:8, 1:9, 9:1, 8:1, 7:1, 6:1, 5:1, 4:1, 3:2, or 2:1 of ethyl butanoate: (E)-ethyl but-2-enoate.

8. The method of claim 5, wherein the repellent composition is contained in a chemical propagator, optionally wherein the chemical propagator is attached directly to at least one individual plant in the agricultural crop.

9. The method of claim 5, wherein the agricultural crop is at least one of apples, oranges, peaches, grapes, pineapples, cherries, pears, guavas, melons, bananas, raspberries, blueberries, strawberries, or blackberries.

10. The method of claim 5, further comprising placing on or next to at least one plant in the agricultural crop an attractive substance that attracts the Drosophila species fly.

11. The method of claim 5, which repels or prevents at least 90% of Drosophila suzukii flies from eating, mating on, or laying eggs on the agricultural crop.

12. The method of claim 10, wherein the attractive substance is in a trap that prevents at least one Drosophila species fly from escaping.

13. A method of suppressing or reducing oviposition of a Drosophila species fly on an agricultural crop, the method comprising:
placing a repellent composition on or next to at least one plant in the agricultural crop, wherein the repellent composition consists essentially of at least one suitable agriculturally-acceptable additive and:
about 1 to about 50% (v/v) of ethyl butanoate and optionally about 1 to about 50% (v/v) of (E)-ethyl but-2-enoate; or
about 1 to about 50% (v/v) of (E)-ethyl but-2-enoate and optionally about 1 to about 50% (v/v) of ethyl butanoate.

14. The method of claim 13, wherein the Drosophila species fly is Drosophila suzukii.

15. The method of claim 13, wherein the repellent composition consists essentially of
about 1 to about 50% (v/v) of ethyl butanoate and (E)-ethyl but-2-enoate; and
at least one suitable agriculturally-acceptable additive,
wherein the ethyl butanoate and (E)-ethyl but-2-enoate are present in a ratio of about 1:1, 1:2, 1:3, 1:4, 1:5, 1:6, 1:7, 1:8, 1:9, 9:1, 8:1, 7:1, 6:1, 5:1, 4:1, 3:2, or 2:1 of ethyl butanoate: (E)-ethyl but-2-enoate.

16. The method of claim 13, wherein the repellent composition is contained in a chemical propagator, optionally wherein the chemical propagator is attached directly to at least one individual plant in the agricultural crop.

17. The method of claim 13, wherein the agricultural crop is at least one of apples, oranges, peaches, grapes, pineapples, cherries, pears, guava, melon, banana, raspberries, blueberries, strawberries, or blackberries.

18. The method of claim 13, further comprising placing on or next to at least one plant in the agricultural crop an attractive substance that attracts the Drosophila species fly.

19. The method of claim 13, which repels or prevents at least 90% of Drosophila suzukii flies from eating, mating on, or laying eggs on the agricultural crop.

20. The method of claim 18, wherein the attractive substance is a trap that prevents at least one Drosophila species fly from escaping.
